(19) United States
(12) Patent Application Publication
(10) Pub. No.: US 2024/0107450 A1
(43) Pub. Date: Mar. 28, 2024

(54) METHODS, TERMINAL, INFRASTRUCTURE EQUIPMENT AND SYSTEM

(71) Applicant: Sony Group Corporation, Tokyo (JP)

(72) Inventors: Yuxin WEI, Basingstoke (GB); Vivek SHARMA, Basingstoke (GB); Hideji WAKABAYASHI, Basingstoke (GB); Yassin Aden AWAD, Basingstoke (GB)

(73) Assignee: Sony Group Corporation, Tokyo (JP)

(21) Appl. No.: 18/274,722

(22) PCT Filed: Feb. 16, 2022
(86) PCT No.: PCT/EP2022/053826

§ 371 Date: Jul. 28, 2023

(30) Foreign Application Priority Data
Feb. 23, 2021 (EP) 21158842.1

(51) Int. Cl. H04W 52/02; H04W 36/08; H04W 76/27

(52) U.S. Cl. CPC H04W 52/0229; H04W 36/08; H04W 52/028; H04W 76/27

(57) ABSTRACT

A mobile telecommunications system comprising first infrastructure equipment and a terminal wherein the terminal is configured to communicate with the first infrastructure equipment via an air interface provided by the first infrastructure equipment, wherein the terminal is configured to: determine that the terminal can trigger an infrastructure equipment search; and transmit, based on determining that the terminal can trigger an infrastructure equipment search, a wake-up signal; and wherein the first infrastructure equipment is configured to: based on the wake-up signal from the terminal, transition to an active state where the first infrastructure equipment provides the air interface for the terminal to communicate with the first infrastructure equipment.

The present application claims the Paris Convention priority of European patent application EP 21158842.1, filed 23 Feb. 2021, the contents of which are hereby incorporated by reference.

### FIELD

The present disclosure relates generally to terminals or communications devices, base stations, infrastructure equipment, systems and methods of operating communications devices, base stations, infrastructure equipment and system.

### DESCRIPTION OF RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Third and fourth generation mobile telecommunication systems, such as those based on the third generation partnership project (3GPP) defined UMTS and Long Term Evolution (LTE) architectures, are able to support more sophisticated services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, may be expected to increase ever more rapidly.

Future wireless communications networks will therefore be expected to routinely and efficiently support communications with a wider range of devices associated with a wider range of data traffic profiles and types than current systems are optimised to support. For example, it is expected that future wireless communications networks will efficiently support communications with devices including reduced complexity devices, machine type communication (MTC) devices, high resolution video displays, virtual reality headsets and so on. Some of these different types of devices may be deployed in very large numbers, for example low complexity devices for supporting the “Internet of Things”, and may typically be associated with the transmission of relatively small amounts of data with relatively high latency tolerance.

In view of this there is expected to be a desire for future wireless communications networks, for example those which may be referred to as 5G or new radio (NR) system/new radio access technology (RAT) systems or as 6G systems, as well as future iterations/releases of existing systems, to efficiently support connectivity for a wide range of devices associated with different applications and different characteristic data traffic profiles. There is similarly expected to be a desire for such connectivity to be available over a wide geographic area with an increasing coverage flexibility.

One example area of current interest in this regard includes so-called “non-terrestrial networks”, or NTN for short. The 3GPP has proposed in Release 15 of the 3GPP specifications to develop technologies for providing coverage by means of one or more antennas mounted on an airborne or space-borne vehicle [1]. Other NTN relevant discussions are also provided in TR 38.821 [3].

Non-terrestrial networks may provide service in areas that cannot be covered by terrestrial cellular networks (i.e. those where coverage is provided by means of land-based antennas), such as isolated or remote areas, on board aircraft or vessels, or may provide enhanced service in other areas. The expanded coverage that may be achieved by means of non-terrestrial networks may provide service continuity for machine-to-machine (M2M) or ‘internet of things’ (IoT) devices, or for passengers on board moving platforms (e.g. passenger vehicles such as aircraft, ships, high speed trains, or buses). Other benefits may arise from the use of non-terrestrial networks for providing multicast/broadcast resources for data delivery.

Other considerations include base stations which provide intermittent coverage and which can be activated and deactivated when appropriate. Such base stations may in some cases be provided by an NTN system, such as base stations provided on drones and/or on other types of space-born vehicles or other types of mobile devices. Alternatively or additionally, these may be provided at fixed location and are activated when desired.

The use of different types of network infrastructure equipment and requirements for coverage enhancement give rise to new challenges for efficiently handling communications in wireless communications systems that need to be addressed. In particular, increasing the number of base stations can increase the power consumption involved in managing the system, e.g. when base stations are active or in the signalling for controlling the base stations.

### SUMMARY

The invention is defined in the appended independent claims. The present disclosure includes example arrangements falling within the scope of the claims (and other arrangements may also be within the scope of the following claims) and may also include example arrangements that do not necessarily fall within the scope of the claims but which are then useful to understand the invention and the teachings and techniques provided herein.

According to a first aspect of the present disclosure, there is provided a mobile telecommunications system comprising first infrastructure equipment and a terminal wherein the terminal is configured to communicate with the first infrastructure equipment via an air interface provided by the first infrastructure equipment, wherein the terminal is configured to: determine that the terminal can trigger an infrastructure equipment search; and transmit, based on determining that the terminal can trigger an infrastructure equipment search, a wake-up signal; and wherein the first infrastructure equipment is configured to, based on the wake-up signal from the terminal, transition to an active state where the first infrastructure equipment provides the air interface for the terminal to communicate with the first infrastructure equipment.

According to a second aspect of the present disclosure, there is provided infrastructure equipment for use in a mobile telecommunications system comprising a terminal wherein the infrastructure equipment is configured to provide an air interface for the terminal and wherein the terminal is configured to communicate with the infrastructure equipment via the air interface, wherein the infrastructure equipment is configured to: based on detecting that the terminal has transmitted a wake-up signal, transition to an active state where the infrastructure equipment provides the air interface for the terminal to communicate with the infrastructure equipment, wherein the transmission by the terminal of the wake-up signal is based on determining that the terminal can trigger an infrastructure equipment search.

According to a third aspect of the present disclosure, there is provided a terminal for use in a mobile telecommunications system comprising first infrastructure equipment and the terminal, wherein the terminal is configured to communicate with the first infrastructure equipment via an air interface provided by the first infrastructure equipment, wherein the terminal is configured to: determine that the terminal can trigger an infrastructure equipment search; and transmit, based on determining that the terminal can trigger an infrastructure equipment search, a wake-up signal.

According to a fourth aspect of the present disclosure, there is provided infrastructure equipment for assisting an on-demand wake-up procedure for first infrastructure equipment and for use in a mobile telecommunications system comprising the first infrastructure equipment, the infrastructure equipment and a terminal wherein the terminal is configured to communicate with the first infrastructure equipment via a first air interface provided by the first infrastructure equipment and is configured to communicate with the infrastructure equipment via a second air interface provided by the infrastructure equipment, wherein the terminal is configured to transmit, while connected to the infrastructure equipment, a wake-up signal and wherein the first infrastructure equipment is configured to transition, based on the wake-up signal from the terminal, to an active state where the first infrastructure equipment provides the air interface for the terminal to communicate with the first infrastructure equipment, wherein the infrastructure equipment is configured to notify the terminal of one or more resources for the terminal to transmit the wake-up signal.

According to a fifth aspect of the present disclosure, there is provided a method of operation a terminal for use in a mobile telecommunications system comprising first infrastructure equipment and the terminal, wherein the terminal is configured to communicate with the first infrastructure equipment via an air interface provided by the first infrastructure equipment, the method comprising the terminal: determining that the terminal can trigger an infrastructure equipment search; and transmitting, based on determining that the terminal can trigger an infrastructure equipment search, a wake-up signal.

According to a sixth aspect of the present disclosure, there is provided circuitry for a terminal for use in a mobile telecommunications system comprising first infrastructure equipment and the terminal, wherein the circuitry comprises a controller element and a transceiver element configured to operate together to communicate with the first infrastructure equipment via an air interface provided by the first infrastructure equipment, wherein the controller element and the transceiver element are further configured to operate together to determine that the terminal can trigger an infrastructure equipment search; and transmit, based on determining that the terminal can trigger an infrastructure equipment search, a wake-up signal.

According to a seventh aspect of the present disclosure, there is provided a method of operating infrastructure equipment for use in a mobile telecommunications system comprising a terminal wherein the infrastructure equipment is configured to provide an air interface for the terminal and wherein the terminal is configured to communicate with the infrastructure equipment via the air interface, the method comprising the infrastructure equipment: transitioning, based on detecting that the terminal has transmitted a wake-up signal, to an active state where the first infrastructure equipment provides the air interface for the terminal to communicate with the infrastructure equipment, wherein the transmission by the terminal of the wake-up signal is based on determining that the terminal can trigger an infrastructure equipment search.

According to a eighth aspect of the present disclosure, there is provided circuitry for a infrastructure equipment for use in a mobile telecommunications system comprising a terminal, wherein the circuitry comprises a controller element and a transceiver element configured to operate together to provide an air interface for the terminal and wherein the terminal is configured to communicate with the infrastructure equipment via the air interface, wherein the controller element and the transceiver element are further configured to operate together to transition, based on detecting that the terminal has transmitted a wake-up signal, to an active state where the first infrastructure equipment provides the air interface for the terminal to communicate with the infrastructure equipment, wherein the transmission by the terminal of the wake-up signal is based on determining that the terminal can trigger an infrastructure equipment search.

According to a ninth aspect of the present disclosure, there is provided a method of operating infrastructure equipment for assisting an on-demand wake-up procedure for first infrastructure equipment and for use in a mobile telecommunications system comprising the first infrastructure equipment, the infrastructure equipment and a terminal wherein the terminal is configured to communicate with the first infrastructure equipment via a first air interface provided by the first infrastructure equipment and is configured to communicate with the infrastructure equipment via a second air interface provided by the infrastructure equipment and wherein the terminal is configured to transmit, while connected to the infrastructure equipment, a wake-up signal and wherein the first infrastructure equipment is configured to transition, based on the wake-up signal from the terminal, to an active state where the first infrastructure equipment provides the air interface for the terminal to communicate with the first infrastructure equipment, the method comprising the infrastructure equipment notifying the terminal of one or more resources for the terminal to transmit the wake-up signal.

According to a tenth aspect of the present disclosure, there is provided circuitry for a infrastructure equipment for assisting an on-demand wake-up procedure for first infrastructure equipment and for use in a mobile telecommunications system comprising the first infrastructure equipment, the infrastructure equipment, wherein the terminal is configured to communicate with the first infrastructure equipment via a first air interface provided by the first infrastructure equipment; wherein the circuitry comprises a controller element and a transceiver element configured to operate together to provide a second air interface for the terminal and wherein the terminal is configured to communicate with the infrastructure equipment via the second air interface; wherein the terminal is configured to transmit, while connected to the infrastructure equipment, a wake-up signal and wherein the first infrastructure equipment is configured to transition, based on the wake-up signal from the terminal, to an active state where the first infrastructure equipment provides the air interface for the terminal to communicate with the first infrastructure equipment; and wherein the controller element and the transceiver element are further configured to operate together to notify the terminal of one or more resources for the terminal to transmit the wake-up signal.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and:

FIG. 1 schematically represents some aspects of an LTE-type wireless telecommunication system which may be configured to operate in accordance with certain embodiments of the present disclosure;

FIG. 2 schematically represents some aspects of a new radio access technology (RAT) wireless telecommunications system which may be configured to operate in accordance with certain embodiments of the present disclosure;

FIG. 3 is a schematic block diagram of an example infrastructure equipment and communications device configured in accordance with example embodiments;

FIG. 4 illustrates an example of an IAB-UAV network;

FIG. 5 illustrates an example method for use with a terminal and with a base station;

FIG. 6 illustrates an example call flow in accordance with techniques of the present disclosure;

FIG. 7 illustrates an example call flow in accordance with techniques of the present disclosure; and

FIG. 8 illustrates another simplified diagram of infrastructure equipment in accordance with techniques of the present disclosure.

### DETAILED DESCRIPTION OF THE EMBODIMENTS

### Long Term Evolution Advanced Radio Access Technology (4G)

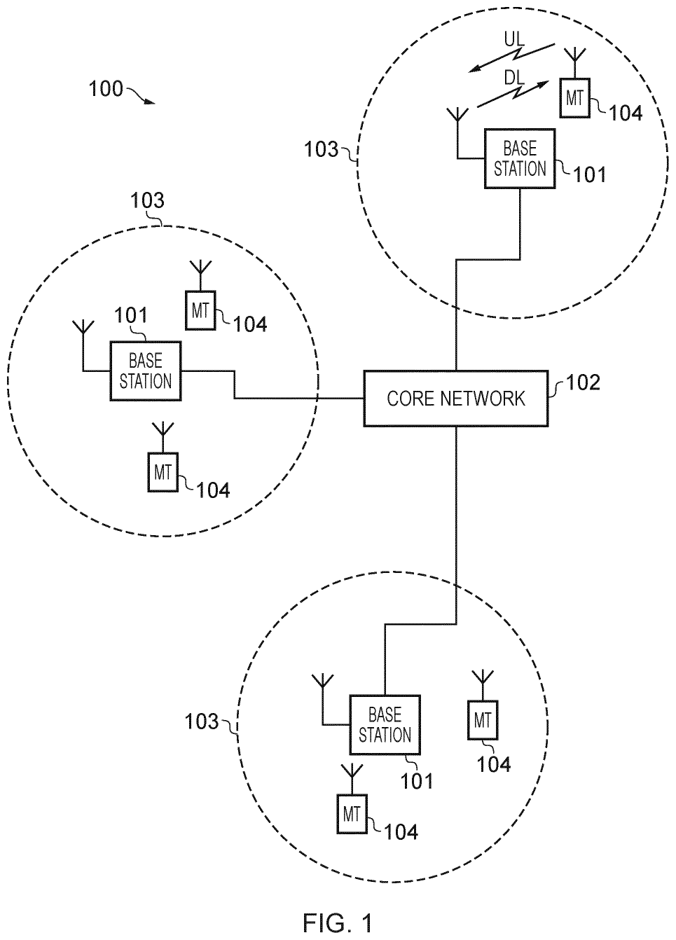

FIG. 1 provides a schematic diagram illustrating some basic functionality of a mobile telecommunications network/system 100 operating generally in accordance with LTE principles, but which may also support other radio access technologies, and which may be adapted to implement embodiments of the disclosure as described herein. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 100 includes a plurality of base stations 101 connected to a core network part 102. Each base station provides a coverage area 103 (e.g. a cell) within which data can be communicated to and from communications devices 104. Data is transmitted from the base stations 101 to the communications devices 104 within their respective coverage areas 103 via a radio downlink. Data is transmitted from the communications devices 104 to the base stations 101 via a radio uplink. The core network part 102 routes data to and from the communications devices 104 via the respective base stations 101 and provides functions such as authentication, mobility management, charging and so on. Communications devices may also be referred to as mobile stations, user equipment (UE), user terminals, mobile radios, terminal devices, and so forth. Base stations, which are an example of network infrastructure equipment/network access nodes, may also be referred to as transceiver stations/nodeBs/e-nodeBs (eNB), g-nodeBs (gNB) and so forth. In this regard, different terminology is often associated with different generations of wireless telecommunications systems for elements providing broadly comparable functionality. However, example embodiments of the disclosure may be equally implemented in different generations of wireless telecommunications systems such as 5G or new radio as explained below, and for simplicity, certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

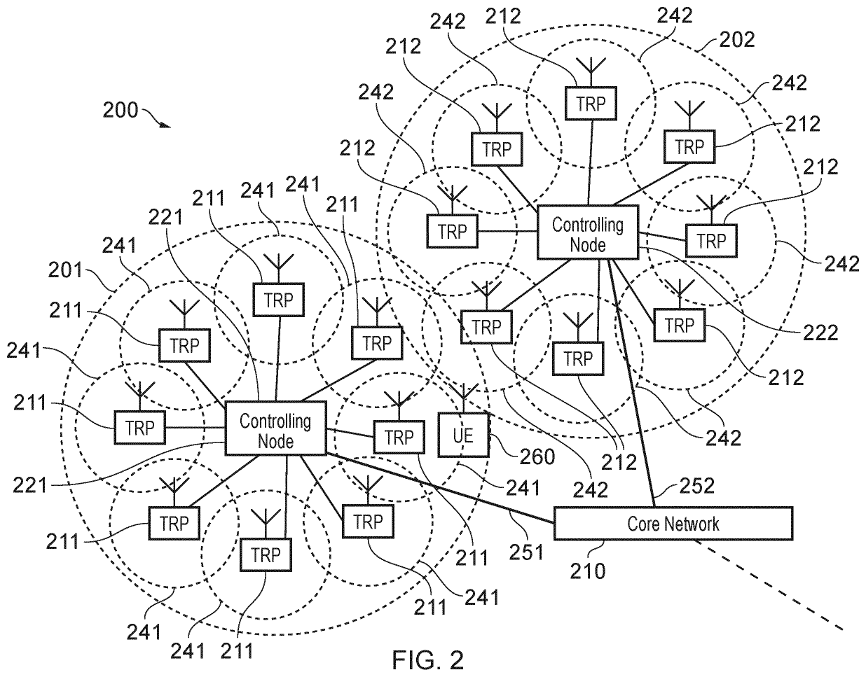

FIG. 2 is a schematic diagram illustrating a network architecture for a new RAT wireless communications network/system 200 based on previously proposed approaches which may also be adapted to provide functionality in accordance with embodiments of the disclosure described herein. The new RAT network 200 represented in FIG. 2 comprises a first communication cell 201 and a second communication cell 202. Each communication cell 201, 202, comprises a controlling node (centralised unit) 221, 222 in communication with a core network component 210 over a respective wired or wireless link 251, 252. The respective controlling nodes 221, 222 are also each in communication with a plurality of distributed units (radio access nodes/remote transmission and reception points (TRPs)) 211, 212 in their respective cells. Again, these communications may be over respective wired or wireless links. The distributed units (DUs) 211, 212 are responsible for providing the radio access interface for communications devices connected to the network. Each distributed unit 211, 212 has a coverage area (radio access footprint) 241, 242 where the sum of the coverage areas of the distributed units under the control of a controlling node together define the coverage of the respective communication cells 201, 202. Each distributed unit 211, 212 includes transceiver circuitry for transmission and reception of wireless signals and processor circuitry configured to control the respective distributed units 211, 212.

In terms of broad top-level functionality, the core network component 210 of the new RAT communications network represented in FIG. 2 may be broadly considered to correspond with the core network 102 represented in FIG. 1, and the respective controlling nodes 221, 222 and their associated distributed units/TRPs 211, 212 may be broadly considered to provide functionality corresponding to the base stations 101 of FIG. 1. The term network infrastructure equipment/access node may be used to encompass these elements and more conventional base station type elements of wireless communications systems. Depending on the application at hand the responsibility for scheduling transmissions which are scheduled on the radio interface between the respective distributed units and the communications devices may lie with the controlling node/centralised unit and/or the distributed units/TRPs.

A communications device or UE 260 is represented in FIG. 2 within the coverage area of the first communication cell 201. This communications device 260 may thus exchange signalling with the first controlling node 221 in the first communication cell via one of the distributed units 211 associated with the first communication cell 201. In some cases, communications for a given communications device are routed through only one of the distributed units, but it will be appreciated in some other implementations communications associated with a given communications device may be routed through more than one distributed unit, for example in a soft handover scenario and other scenarios.

In the example of FIG. 2, two communication cells 201, 202 and one communications device 260 are shown for simplicity, but it will of course be appreciated that in practice the system may comprise a larger number of communication cells (each supported by a respective controlling node and plurality of distributed units) serving a larger number of communications devices.

It will further be appreciated that FIG. 2 represents merely one example of a proposed architecture for a new RAT communications system in which approaches in accordance with the principles described herein may be adopted, and the functionality disclosed herein may also be applied in respect of wireless communications systems having different architectures.

Thus example embodiments of the disclosure as discussed herein may be implemented in wireless telecommunication systems/networks according to various different architectures, such as the example architectures shown in FIGS. 1 and 2. It will thus be appreciated the specific wireless communications architecture in any given implementation is not of primary significance to the principles described herein. In this regard, example embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 101 as shown in FIG. 1 which is adapted to provide functionality in accordance with the principles described herein, and in other examples the network infrastructure equipment/access node may comprise a control unit/controlling node 221, 222 and/or a TRP 211, 212 of the kind shown in FIG. 2 which is adapted to provide functionality in accordance with the principles described herein.

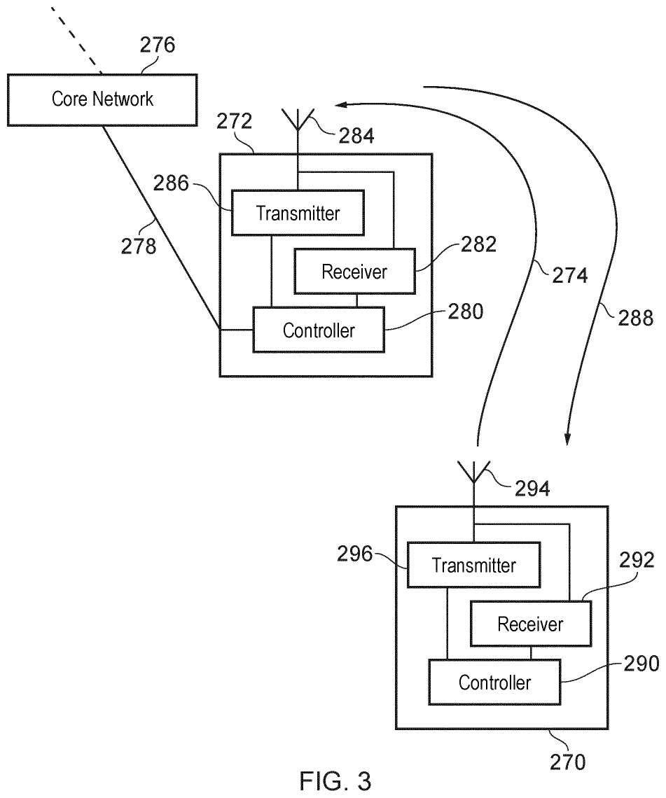

A more detailed illustration of a communications device 270 and an example network infrastructure equipment 272, which may be thought of as an eNB or a gNB 101 or a combination of a controlling node 221 and TRP 211, is presented in FIG. 3. As shown in FIG. 3, the communications device 270 is shown to transmit uplink data to the infrastructure equipment 272 of a wireless access interface as illustrated generally by an arrow 274. The UE 270 is shown to receive downlink data transmitted by the infrastructure equipment 272 via resources of the wireless access interface as illustrated generally by an arrow 288. As with FIGS. 1 and 2, the infrastructure equipment 272 is connected to a core network 276 (which may correspond to the core network 102 of FIG. 1 or the core network 210 of FIG. 2) via an interface 278 to a controller 280 of the infrastructure equipment 272. The infrastructure equipment 272 may additionally be connected to other similar infrastructure equipment by means of an inter-radio access network node interface, not shown on FIG. 3.

The infrastructure equipment 272 includes a receiver 282 connected to an antenna 284 and a transmitter 286 connected to the antenna 284. Correspondingly, the communications device 270 includes a controller 290 connected to a receiver 292 which receives signals from an antenna 294 and a transmitter 296 also connected to the antenna 294.

The controller 280 is configured to control the infrastructure equipment 272 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 280 may comprise circuitry which is suitably configured/programmed to provide the desired functionality using conventional programming/configuration techniques for equipment in wireless telecommunications systems. The transmitter 286 and the receiver 282 may comprise signal processing and radio frequency filters, amplifiers and circuitry in accordance with conventional arrangements. The transmitter 286, the receiver 282 and the controller 280 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the infrastructure equipment 272 will in general comprise various other elements associated with its operating functionality.

Correspondingly, the controller 290 of the communications device 270 is configured to control the transmitter 296 and the receiver 292 and may comprise processor circuitry which may in turn comprise various sub-units/sub-circuits for providing functionality as explained further herein. These sub-units may be implemented as discrete hardware elements or as appropriately configured functions of the processor circuitry. Thus the controller 290 may comprise circuitry which is suitably configured/programmed to provide the desired functionality using conventional programming/configuration techniques for equipment in wireless telecommunications systems. Likewise, the transmitter 296 and the receiver 292 may comprise signal processing and radio frequency filters, amplifiers and circuitry in accordance with conventional arrangements. The transmitter 296, receiver 292 and controller 290 are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/circuitry/chip(s)/chipset(s). As will be appreciated the communications device 270 will in general comprise various other elements associated with its operating functionality, for example a power source, user interface, and so forth, but these are not shown in FIG. 3 in the interests of simplicity.

The controllers 280, 290 may be configured to carry out instructions which are stored on a computer readable medium, such as a non-volatile memory. The processing steps described herein may be carried out by, for example, a microprocessor in conjunction with a random access memory, which may be non-volatile memory, operating according to instructions stored on a computer readable medium.

### Non-Terrestrial Networks (NTNs)

An overview of NR-NTN can be found in [1]. As a result of the wide service coverage capabilities and reduced vulnerability of space/airborne vehicles to physical attacks and natural disasters, Non-Terrestrial Networks are expected to:
foster the roll out of 5G service in un-served areas that cannot be covered by terrestrial 5G network (isolated/remote areas, on board aircrafts or vessels) and underserved areas (e.g. sub-urban/rural areas) to upgrade the performance of limited terrestrial networks in a cost effective manner;
reinforce the 5G service reliability by providing service continuity for M2M/IoT devices or for passengers on board moving platforms (e.g. passenger vehicles-aircraft, ships, high speed trains, bus) or ensuring service availability anywhere especially for critical communications, future railway/maritime/aeronautical communications; and to
enable 5G network scalability by providing efficient multicast/broadcast resources for data delivery towards the network edges or even user terminal.

The benefits relate to either Non-Terrestrial Networks operating alone or to integrated terrestrial and Non-Terrestrial networks. They will impact at least coverage, user bandwidth, system capacity, service reliability or service availability, energy consumption and connection density. A role for Non-Terrestrial Network components in the 5G system is expected for at least the following verticals: transport, Public Safety, Media and Entertainment, eHealth, Energy, Agriculture, Finance and Automotive. It should also be noted that the same NTN benefits apply to 4G and/or LTE and/or future technologies and that while NR is sometimes referred to in the present disclosure, the teachings and techniques presented herein are equally applicable to 4G and/or LTE and/or future technologies (e.g. 6G).

### ITU Network 2030 Architecture Framework

In a 6G era, it is expected that the share of the wireless communication extending to a space or air-borne dimension will increase. For example, a greater number of satellite, drone, Unmanned Aerial Vehicle “UAV” and other examples of air-borne base station is expected to be included in the mobile networks, bringing with them new challenges in both access link as well as backhaul link.

The ITU document entitled “Network 2030 Architecture Framework” [2] mentions the following in respect of space networking:
“Satellite-based networking, or say space network, can bring benefit especially in the long distance communication [1] and wider access coverage especially in rural areas. The space network has been considered as one of the important components of 2030 network. The future space network can not only work internally, but also cooperate with the existing network infrastructures and then become a space-terrestrial network, which intent to deploy a unified network protocol suite. This document aims to highlight specific scenarios and our envisaged technical challenges in the future integration of space networks with the current terrestrial Internet infrastructure in a seamless manner. Here we mainly focus on the Low Earth Orbit (LEO) satellite system which is able to provider low end-to-end latency as compared to its GEO (Geostationary Earth Orbit) counterpart. The common vision in this scenario is that multiple (up to thousands) LEO satellites can be interconnected to form a network infrastructure in the space which will be further integrated with the network infrastructures on the ground. On the other hand, the key challenge in this case is the frequent handover between the two networks caused by the constellation behaviors at the LEO satellite side.” (section 11)

Among those different types of air-borne base stations, the UAV base station is expected to become desirable at least because of a higher potential for a solution enabling an easy deployment at optimum or desired location in 3D space, provision of better performance of coverage/offloading while maintaining relatively low costs (e.g. compared to other aerial solution).

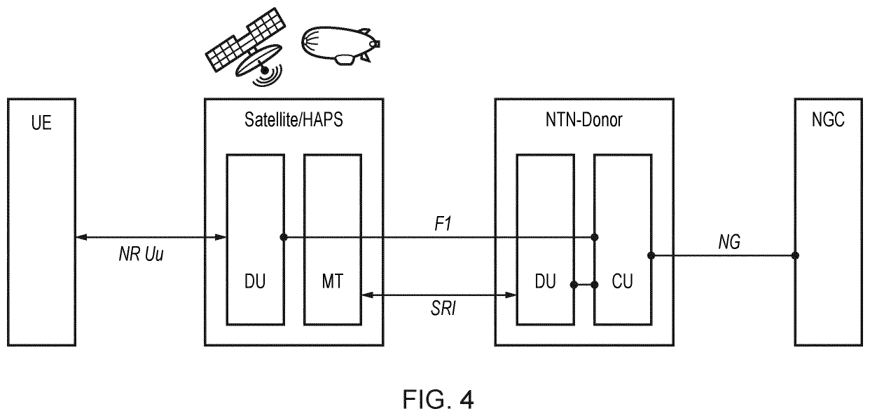

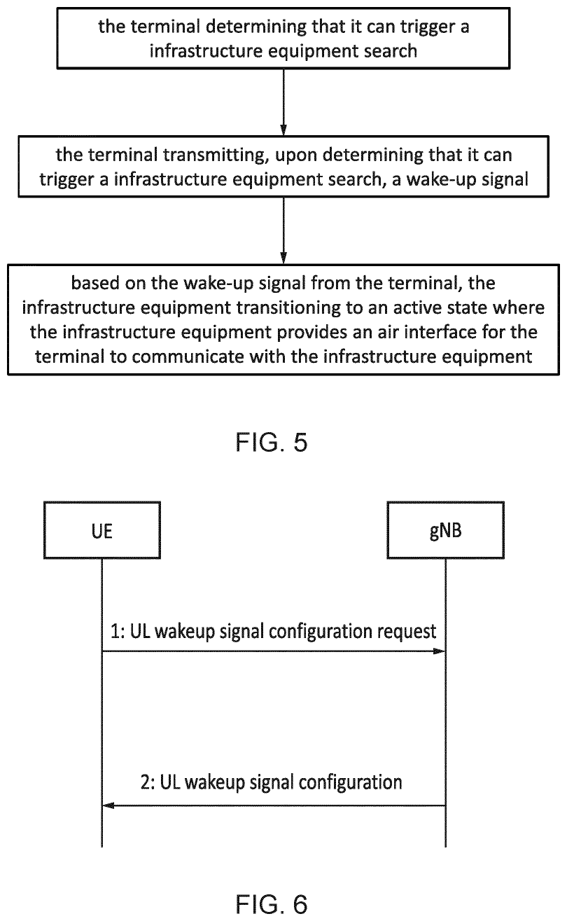

It will be appreciated that while in some cases a base station (e.g. aerial base station) could operate as a single base station by connecting directly to both terminals and to the core network. In other cases, the base station can cooperate and/or communicate with the core network or terminals through one or more additional base station. For example, FIG. 4 (corresponding to FIG. 5.2-4 of R3-185310 [4]) illustrates an example of IAB-UAV network where a base station connects to the core network through a Donor base station (and in this example, connects directly to the terminal through an air interface).

IEEE document “SLEEP Mode Techniques for Small Cell Deployments” [5] discusses using an UE-controlled sleep mode, and reads for example in the “UE CONTROLLED SLEEP MODE” section:
“A third approach is to place the SLEEP mode control at the UE side, which can broadcast wake-up signals in order to wake up small cell base stations within its range. The small cell, when in SL state, retains the capability to receive wake-up signal transmissions from the UE, and any time such signals are received, it transitions to RE state.”
“This solution can be implemented in various ways. The UE can broadcast periodic wake-up signals continuously so that any small cells in SL state will transition to RE state when the UE approaches it. This means that coverage provided by small cells “follows” a UE unit as it moves around and ensures that UE units are given small cell coverage whenever possible.”
“An alternative implementation strategy is for the UE to broadcast wake-up signals when required on demand, such as in the absence of sufficient macrocell coverage or for higher data rate requirements. In such a situation, the UE can transmit broadcasts to attempt to wake up any small cells within range. The UE can also perform these broadcasts prior to establishing a connection with the network. This enables the UE to wake up any small cells first and then connect directly through a small cell.”

In legacy mobile networks, the base station sends one or more always-on reference signals (e.g. PSS/SSS/PBCH) which allow the UEs to detect and initiate a connection (e.g. random access) afterwards. However, in a 6G era, it is expected that, at least in some situation, the opposite could happen with a base station discovering, tracking and/or following UEs or UE groups and providing corresponding services to them thereafter. One of the challenges is determining how to allow the base station to discover the UE that wants to access the network in an optimal manner.

In accordance with techniques of the present disclosure, the terminal can transmit a wake-up signal on an on-demand basis in order to discover a new base station (or for the base station to discover the terminal, or both) such that the terminal can communicate via at least the new base station.

It should be noted that while some of the techniques provided herein are particularly well suited to be used with aerial base stations (e.g. the new base station being an aerial base station), the techniques are equally applicable to terrestrial base stations. Likewise, in some cases, the new base station may be a relay or an intermediate node providing an indirect interface to a core network and the teachings provided herein in respect of base stations can apply equally to relays or intermediate nodes. In other words, these techniques are application to any infrastructure equipment which is configured to provide an air interface to communicate with the terminal (e.g. to connect the terminal to the network or to other elements of the network).

FIG. 5 illustrates an example method for use with a terminal and with a base station. First, the terminal determines that it can trigger a base station search. Based on determining that the terminal can trigger a base station search, the terminal transmit a wake-up signal. Based on the wake-up signal from the terminal, the base station can transition to an active state wherein the base station provides an air interface for the terminal to communication with the base station.

For example the first infrastructure equipment may be configured to transition to the active state from a dormant state, the dormant state being state in which the first infrastructure equipment does not provide the air interface and in which the first infrastructure equipment monitors uplink signals for wake-up signals. Alternatively or additionally, the first infrastructure equipment may be configured to transition to the active state from a dormant state, the dormant state being state in which the transmitter of the first infrastructure equipment is inactive.

In some cases, the terminal is configured to determine that the terminal can trigger an infrastructure equipment search while being connected to a second infrastructure equipment (e.g. when the terminal is in a connected or RRC_connected mode). The terminal may for example be configured to determine that the terminal can trigger an infrastructure equipment search based on one or more of:
the terminal determining that the second infrastructure equipment does not provide a service that the terminal is configured to use;
the terminal determining that its coverage level is degrading;
the terminal determining that its coverage level is degrading and that the terminal cannot identify a currently active infrastructure equipment with a suitable coverage level;
the terminal determining that its coverage level is dropping under a predetermined threshold;
the terminal determining that its coverage level is dropping under a predetermined threshold and that the terminal cannot identify a currently active infrastructure equipment with a suitable coverage level;
the terminal determining that a moving status or trajectory for the terminal has changed;
the terminal determining that a number of retransmissions is increasing;
the terminal determining that a congestion level is above an acceptable congestion level; and
the terminal determining that an interference level is above a suitable interference level.

In some cases, the second infrastructure equipment may notify the terminal of one or more resources for the terminal to transmit a wake-up signal, and optionally of further wake-up signal configuration information. In some cases, the one or more resources for the terminal to transmit a wake-up signal can be previously notified by the first infrastructure equipment to the second infrastructure equipment. In some cases, the terminal is configured to transmit a wake-up signal configuration request; and the second infrastructure equipment is configured to notify the terminal of one or more resources for the terminal to transmit a wake-up signal in response to the wake-up signal configuration request. In some cases, the second infrastructure equipment may be configured to, after receiving the wake-up signal configuration request from the terminal, communicate to the first infrastructure equipment one of or both of a cell identifier for a cell provided by the second infrastructure equipment and a terminal identifier for the terminal.

The terminal may also be configured to transmit the wake-up signal wherein receipt by the first infrastructure equipment of the wake-up signal from the terminal comprises the first infrastructure equipment detecting the wake-up signal. For example, the terminal may be configured to transmit the wake-up signal to the second infrastructure equipment and wherein receipt by the first infrastructure equipment of the wake-up signal from the terminal comprises the first infrastructure equipment detecting the wake-up signal sent to the second infrastructure equipment. In other words, to simplify the wake-up signal transmission, it may be sent to the serving infrastructure equipment even though the intended receipt is one or more other infrastructure equipment.

The terminal may also be configured to transmit a scrambled signal as the wake-up signal, the scrambled signal being scrambled with one of or both of a cell identifier for a cell provided by the second infrastructure equipment and a terminal identifier for the terminal. For example, the first infrastructure equipment may also be configured to recognise one of or both of the cell identifier and the terminal identifier, respectively, from the scrambled signal. In some cases, the second infrastructure equipment may also be configured to transmit one or both of the cell identifier and the terminal identifier to the first infrastructure equipment.

The second infrastructure equipment may also be configured to, upon receipt of the wake-up signal by the second infrastructure equipment, to transmit a further wake-up signal, the further wake-up signal being associated with an identifier for the terminal. For example, the further wake-up signal may be scrambled with the identifier for the terminal. In this case, the wake-up signal of the terminal may be configured to correspond to a wake-up signal configuration request. However, regardless of the form taken by this signal, it will serve to wake the first infrastructure equipment up, through the second infrastructure equipment sending a further wake-up signal in response. It should be noted that in some cases the terminal may send yet another wake-up signal. For example, the wake-up signal may take the form of a wake-up configuration request signal, the second (e.g. serving) infrastructure equipment may send a further wake-up signal (e.g. to the first infrastructure equipment) and the terminal may send yet another wake-up signal (e.g. based on information and/or resources identified in response to the first wake-up signal.

In some examples, the second infrastructure equipment may be configured to transmit wake-up signal configuration information to the terminal, the wake-up signal configuration information identifying one or more time and/or frequency resources for transmitting the wake-up signal. The terminal may then be configured to transmit the wake-up signal based on the received wake-up signal configuration information and wherein the first infrastructure equipment may then be configured to detect the wake-up signal from the terminal based on the wake-up signal configuration information. For example, the wake-up signal configuration information might have been previously communicated by the first infrastructure equipment to the second infrastructure equipment.

The terminal may be configured to, upon determining that the terminal can trigger an infrastructure equipment search, transmit a configuration information request to the second infrastructure equipment and to, upon receipt of a configuration request response, transmit the wake-up signal based on the configuration request response.

The second infrastructure equipment may be configured to select the first infrastructure equipment from a plurality of infrastructure equipment having detected the wake-up signal, for transitioning the first infrastructure equipment to the active state. This may for example be based on notifications received from the first infrastructure equipment and a further infrastructure equipment that the first infrastructure equipment and the further infrastructure equipment have detected the transmitted wake-up signal.

In some cases, the first infrastructure equipment is configured to communicate with other infrastructure equipment, based on the other infrastructure equipment receiving the wake-up signal from the terminal. Together, they can make a collective decision to elect one of them for transitioning to the active state. This may for example be based on a requested service, a location of the terminal and/or the infrastructure equipment, a quality of link between the terminal and each of the infrastructure equipment, slice information, a mobility status for the terminal and/or the infrastructure equipment, etc. Different algorithms may be used for making the decision, such as cluster-head selection algorithms. In some cases, the infrastructure equipment that have detected the wake-up signal from the terminal can notify the serving base station and, if appropriate, be notified of one or more other infrastructure equipment that have also received the wake-up signal. In some cases, the infrastructure equipment that has detected the wake-up signal from the terminal can notify other infrastructure equipment in a proximity area, e.g. via an interface between infrastructure equipment, thereby assisting with the identification of which infrastructure equipment have received the wake-up signal. For example, they may use the X2 interface to exchange information such as one infrastructure informing neighbouring infrastructure equipment via the direct infrastructure equipment (e.g. X2) interface that it has received a wake-up signal. The same the direct infrastructure equipment (e.g. X2) interface may be used for communications for reaching a collecting decision.

If the first infrastructure equipment is elected, it can then transition to the active state.

In some cases, upon receipt of the wake-up signal from the terminal, the first infrastructure equipment can transition to a broadcasting state wherein, in the broadcasting state, the first infrastructure equipment is configured to transmit a reference signal. The terminal can then detect the reference signal and based on the reference signal (and possibly on reference signals from other infrastructure equipment) and determine whether to connect to the first infrastructure equipment (or another one, if appropriate). It should be noted that in some cases the broadcasting state can be the same as the active state while in other cases it may be more limited than an active state (e.g. by providing fewer functionalities). In the latter case, the first infrastructure equipment may transition to the active state when it determines that the terminal is connecting to the first infrastructure equipment. Optionally, the first infrastructure equipment may be configured to determine that it has been in the broadcasting state for at least a predetermined amount of time and that the terminal has not contacted the first infrastructure equipment or connected to the first infrastructure equipment (e.g. because the terminal has selected another infrastructure equipment or has not connected to any infrastructure equipment). The first infrastructure equipment may then be configured to transition, based on this determination, from the broadcasting state to a dormant state. For example, the dormant state may be a state in which the first infrastructure equipment does not provide the air interface and in which the first infrastructure equipment monitors uplink signals for wake-up signals.

The second infrastructure equipment may be configured to transmit, to the terminal, handover or connection information for the first infrastructure equipment. For example, the second infrastructure equipment may be configured to receive first handover or connection information from the first infrastructure equipment, wherein the transmitted handover or connection information is based on the first handover or connection information.

In some cases, the terminal may be configured to determine, when it is in a non-connected state (e.g. in an idle and/or inactive state or mode), that the terminal can trigger an infrastructure equipment search based on one or more of:
the terminal determining that it will transition to a connected state;
the terminal determining that it will perform a cell selection or re-selection procedure; and
the terminal determining that a moving status or trajectory for the terminal has changed;

The first infrastructure equipment may be configured to transmit, once transitioned to the active state, one or more of: a reference signal, system information and synchronisation information. For example, the first infrastructure equipment may be configured to transmit the reference signal at a higher power during in a time period following the detection of the wake-up signal and/or by directing its transmitter in a detected direction of the terminal based on the detection of the wake-up signal.

The first infrastructure equipment may be configured to determine, while in the active state, if it has received a keep-awake message (e.g. within a time period such as a rolling time period) or notification; if a notification is received, remain in the active state; and if a notification is not received, transition to a dormant state. For example, the first infrastructure equipment may be configured to transmit, while in the active state, a notification indicating that the first infrastructure equipment intends to go to sleep, where the keep-awake message is transmitted in response to the notification. The first infrastructure equipment may also make the determination by determining if a keep-awake message has been received in a time period and/or by determining that a keep awake message has either not been received or that the last keep awake message has received for longer than a predetermined period of time.

The terminal may be configured to transmit the wake-up signal based on a first transmission configuration when the determination that the terminal can trigger an infrastructure equipment search is based on a first criterion and to transmit the wake-up signal based on a second transmission configuration (different from the first transmission configuration) when the determination that the terminal can trigger an infrastructure equipment search is based on a second criterion (different from the first criterion). The first infrastructure equipment may then be configured to transition to the active state based on whether the transmission configuration used for transmitting the wake-up signal is associated with a criterion matching the first infrastructure equipment.

The first (or second) infrastructure equipment above may be any of a base station, relay, IOT relay, IAB node, drone, rural areas nomadic base stations, etc.

Accordingly, using an on-demand uplink wake-up signal from terminal can enable a potential base station to discover the terminal, for example to provide one or more desired services thereafter.

Some of the expected benefits or aspects of the techniques provided herein are discussed below.

### 1. The Signal can be Transmitted on Demand.

This can help avoiding a situation where a terminal may keep sending a reference signal. While such a reference signal announcing the presence of the terminal may be somewhat simpler to implement in a system, it would also be a heavy burden in terms of power utilisation and is likely to be unnecessary in many cases. When a wake-up signal is sent on an on-demand basis, it may only be sent when deemed necessary.

Example scenarios include:
a. A terminal may wish to use, trigger or start a service or type of service which the current and/or nearby base stations are unable to provide. For example, in the case of an event, drone, aerial, mobile or terrestrial base station may be deployed (e.g. in and/or around an arena) to provide or help provide an online broadcast service. These base stations could be in dormant state until the first spectator enters and become active when spectators are present. In some cases, the base stations may be configure to provide only a particular type of broadcast and in other cases they may be configured to increase the capacity of the network in the vicinity of the event (e.g. to deal with an expected traffic increase, especially if spectators are using broadcasting services).
b. A terminal is expecting that it will lose its coverage. For example, the coverage provided by the current base station may be falling under a quality threshold and the terminal may also in some cases attempt to identify an alternative base station amongst the already active base station. In cases where the terminal has identified that it is unable to identify an active base station providing sufficient coverage, it may determine that it is appropriate to transmit a wake-up signal.

For example, in a rural area or a low-population area, mobile base stations can be deployed to cover such an area and can move to this or another area quickly enough when there is communication demand. This can for example help save the cost of deploying a fixed base station which is expected to have a number of users and/or a low utilization level. In this or other examples, such base stations may be deployed on a seasonal basis, for example can be used in a first area popular at a first time of the year and can later be used in a second area at a second time of the year (e.g. when the first is less popular and when the second area is busier). In some cases, lightweight or drone base stations can provide a service on demand. Such a base station can be in sleep mode unless awaken by a terminal which may be in the vicinity of the base station and which transmits a wake-up signal.
c. A terminal has lost its coverage in a disaster situation. For example, backup base stations can be deployed only for emergency cases. Those base stations are in sleep state unless a disaster strikes, and those base stations can be triggered or activated by the terminals who suddenly lose their coverage from their serving cells. In some cases, they can be configured to provide emergency services (first or exclusively).

### 2. The Signal can be Multi-Functional.

In some examples, this signal may be implemented to provide one or more of following:
a. Trigger a standby base station to provide one or more particular services, e.g. on demand network, emergency services, broadcast service, general connectivity to the mobile network, etc.
b. Assist a terminal handover to a temporary base station when the network coverage is limited e.g. in rural area, mountains, depopulated area, overcrowded area (for example if base stations are unable to serve all terminals well), etc.
c. Assist a terminal to find a desired base station.

### 3. The Signal is Expected to Improve Energy Efficiency.

As discussed above, in cases where a base station can be activated by a terminal, with techniques provided herein the terminal won't send UL wake-up signal unless it is believed it would be appropriate or helpful to do so. On the other hand, a base station (e.g. a drone terminal deployed for an on-demand network, or an emergence UAV base station) can stay in dormant state for longer. When dormant, it will not need to transmit always-on reference signal or cell information, therefore reducing the energy consumption for the base station as well.

It is also noteworthy that as these techniques may be implemented with for example IOT relays, IAB nodes or other infrastructure equipment which may be deployed in rural areas which may be activated or triggered only when there are customers nearby.

In some implementations, when there are no terminals (e.g. including connected, inactive and idle terminals) within the coverage of a base station (or other infrastructure equipment), the base station can go to sleep except the part to receive the UL wake-up signal e.g. wake-up signal receiver. For example, the base station can deactivate its transmitter and only maintain receiving capabilities. In some cases, the base station can only maintain the functions for receiving potential UL wake-up signal and deactivate other uplink signals receiving capabilities. By deactivating the downlink of the base station, the base station is not expected to transmit any reference signal, which is notably different from legacy system (such as Release 12 small cells) where a discovery or reference signal is transmitted even when they are off or inactive or when they do not have any users.

In cases where multiple base stations receive the wake-up signal, there may be a coordination procedure between these base stations to decide which one/ones would be the most appropriate base stations to service this terminal.

### Connected Mode

First, we will consider cases where the terminal is already in RRC_Connected mode, that is, where the terminal is already connected and serviced by a serving base station (or other infrastructure equipment).

In an RRC connected mode, the terminal already has a serving base station and cell that it is connected to. In some cases, when the terminal has such a serving base station and/or is in RRC connected mode, it can send a wake-up signal when one of a set of one or more conditions is met. For example:
The terminal intends to initiate a service that is not or cannot be provided by its serving cell(s);
The terminal intends to initiate a service that is not or cannot be provided by its serving cell(s) or by active cell(s) it can detect;
A quality of its serving cell is degrading, for example below a threshold;
A quality of its serving cell is degrading, for example below a threshold and it has been unable to identify a suitable active cell, for example:
   A cell with a suitable signal quality (e.g. above the same or a further threshold)
   A cell providing one or more services that the terminal is using and/or intends to use

It should be noted that further aspects may be taken into consideration when determining whether to transmit a wake-up signal. For example, a location of the terminal may be used to make the determination. In some cases, the terminal is provided with a map associated one or more location with wake-up signal configuration, such as an association between cell number and an indicator of the likely or possible presence of one or more dormant base stations, or any other suitable mapping information.

### Terminal

The terminal or UE is expected to determine that it will send a wake-up signal and to transmit the wake-up signal in response to the determination.

FIG. 6 illustrates an example call flow in accordance with techniques of the present disclosure. In some cases, the UE can send an UL wake-up signal configuration request to its serving cell. The base station can respond with configuration information of this signal, e.g. information identifying one or more of: time-frequency resources, power, periodicity, etc. The terminal may send the configuration request as a precaution or may send the configuration request when it is expects to make use of the wake-up signals procedures. In some cases, this can be determined based on a set of one or more conditions which are the same as the set for determining to start a candidate base station search, which are different but related to the set for determining to start a candidate base station search (e.g. where a minimum or maximum threshold is relatively higher or lower, respectively, than the corresponding value for sending a wake-up signal) or may be defined independently from the other set (if provided).

It is expected that in most cases, the configuration information will be based on corresponding configuration information from base station which will monitor the wake-up signals. For example, a candidate base station may notify the serving base station of its wake-up signal monitoring configuration (e.g. time and/or frequency resources that will be monitored). It is also conceivable that the serving base station may determine the wake-up signal resources and/or configuration and notify both the terminal and one or more candidate base stations of the signals to use. While this may be difficult to implement in some case, it may for example be useful in cases where the candidate base station are all expected to serve terminals in the serving cell as in this case, fewer resources have to be reserved for the transmission of wake-up signals. Also, the configuration will also be simpler for the terminal to handle and will require fewer transmissions (e.g. only a single signal for all candidates rather different wake-up signals for different candidates in the area).

In some examples, the UE is configured to scramble its wake-up signal with an identifier for its serving cell and/or an identifier for the UE (e.g. C-RNTI). Accordingly, when a candidate gNB receives this signal, it can deduce which cell the UE belongs to and/or which UE it is, respectively.

Using the obtained configuration, the UE can send a UL wake-up signal when it has determined that it should search for a candidate base station.

In cases where the configuration is provided by the base station, the wake-up signal configuration can be shared by the candidate base stations. This may be done via direct transmission from the candidate base station and/or via other means, e.g. by retrieving a suitable configuration manually or using a node storing wake-up signal configuration for a plurality of base stations of the network. Accordingly, candidate base stations may determine one or more time periods and/or frequency resources for listening to wake-up signals and notify the neighbouring base stations of the wake-up signal configuration.

It should be noted that in some cases the wake-up signal configuration may be partially or fully pre-configured where the terminal can identify which time and/or frequency resources to use thereby dispensing with the step of obtaining any wake-up signal configuration from the serving base station. For example, the resources may be the same everywhere within a network or in a group of cells, the resources may be derivable from the cell-ID, etc.

Also, in some case the wake-up signal configuration (if provided by the base station) may be provided on a regular basis (e.g. in system information or other broadcasted signalling) rather than on an on-demand basis as illustrated in FIG. 6. As the skilled person will appreciate, providing the configuration periodically may be beneficial when the use of wake-up signal may justify the additional signalling and providing the configuration upon request is more likely to be appropriate in cases where the use of wake-up signals is expected to be less widespread.

It is also noteworthy that where a DU-CU (Distributed Unit-Central Unit) architecture, it is expected that the request for configuration will be sent to CU and that the CU will reply with the corresponding configuration.

### Serving Base Station

In some example, the serving gNB can be aware of a nearby candidate base station. For example, it can know that there is at least one candidate base station (e.g. aerial base stations) which can cover at least some of its cell (e.g. whose cell can overlap with the serving cell). As mentioned above, in some cases, the serving base station will share the wake-up signal configuration with such candidate base stations, either directly or indirectly or the candidate base stations will share their respective wake-up signal configurations with the serving base station, either directly or indirectly. In such cases, the exchange of configuration information between the base stations will distribution of the appropriate configurations that the candidate base stations will use in the monitoring of wake-up signals.

In implementations such as the one illustrated in FIG. 6, after the serving base station receives the request from the UE, the serving gNB can in some cases forward its cell ID together with the ID of the requesting UE to nearby candidate base stations. This may for example be helpful to notify the nearby base stations when the terminal is configured to request the wake-up signal configuration prior to sending the wake-up signal (e.g. because it has determined that it will send or is likely to send a wake-up signal). This can allow the candidate gNB to discover the corresponding UL wake-up signal once sent by the terminal.

Additionally or alternatively, after the serving gNB receives a UL wake-up signal configuration request from a connected UE, the serving gNB can send a wake-up signal to a candidate base station, instead of UE. From one perspective, when the UE is in a connected mode with a serving base station (e.g. RRC connected), the serving base station is often expected to have sufficient information to notify nearby candidate base station(s) on behalf of the UE. This may help the UE save power for the UE. This can for example be sent by the base station as an uplink signal to the candidate base station(s). For example, if the signal is scrambled with the UE identifier, the candidate base station may assume that it was sent by the terminal and may not be aware that it was sent by the terminal but by its serving base station.

It will also be appreciated that there may be some benefits associated with having the terminal sending a wake up signal (either regardless or without the base station sending a wake-up signal to a candidate base station). This is because the candidate base station may be configured to respond to the wake-up signal differently depending on how it was received at the candidate base station. For example, in cases where the received signal was weak or below an expected quality level, the candidate base station may determine that it is in fact not a suitable candidate. Accordingly, it may ignore or disregard the wake-up signal, respond to the terminal to decline to activate and/or notify the base station that it will not activate.

### Candidate Base Station

When the candidate base station is woken up or activated by a wake-up signal from a terminal and if the candidate base station determine that a handover is appropriate, the candidate base station can send corresponding handover configuration to the serving base station to facilitate the handover.

If multiple candidate base stations receive the wake-up signal from the UE, a coordination mechanism might be put in place to decide which of the base stations might identified as the optimal base station for the terminal.

In one example, information can be exchanged between the serving base station and the candidate base stations to assist with the decision. Such information can include position of the candidate base station, service information, slice information, mobility status, etc. and/or information regarding the received signal, such as the terminal ID identified, a signal strength or quality indicator, etc.

In cases where the techniques provided herein are implemented in a DU-CU architecture, the CU can configure the DU who can support the wake-up signal monitoring on the receiver. Such configuration can for example be transmitted on the CU-DU interface. When a DU is activated and a handover is deemed appropriate, the CU can send corresponding handover configuration to UE.

Once active or activated, the candidate base station can start transmitting downlink information, e.g. one or more of: synchronisation signals, Synchronization Signal Blocks “SSBs”, system information, etc. The terminal may then be able to detect the activated base station and communicate with the base station.

In some implementations, the candidate base station can send a wake-up signal acknowledgement to the terminal. This may be for example useful in systems where synchronisation may not be required for the terminal to communicate with the candidate base station. In cases where wake-up signal configuration is sent to the terminal, an acknowledgment configuration may be included which defines where (e.g. which time and/or frequency resources) the terminal can receive this acknowledge signal. It will be appreciated that the comments made above in respect of wake-up signal configuration apply equally and the acknowledgement configuration may be partially or fully preconfigured and may be communication in ways other than described in respect of FIG. 6. In cases where the UE receives such a wake-up acknowledgement message to the terminal, the UE can start its communications with the candidate base station straight away.

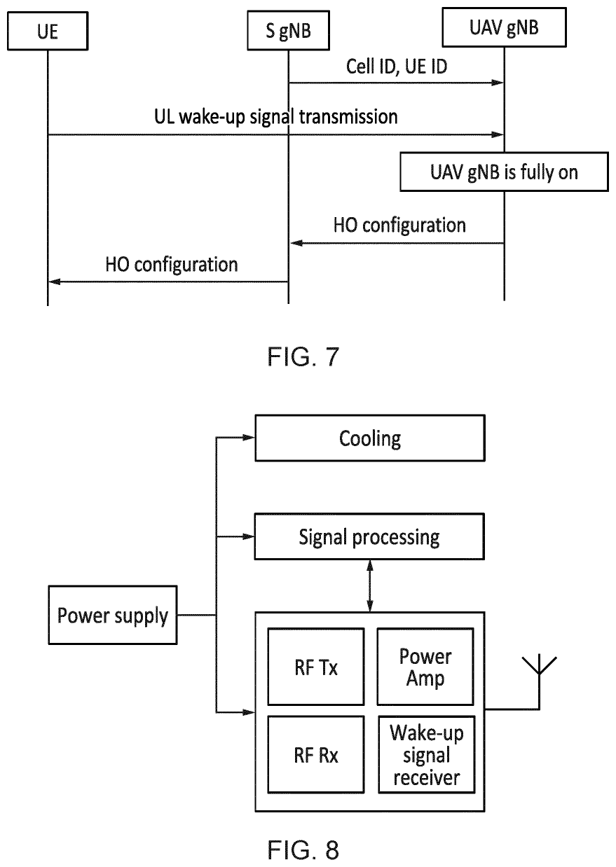

FIG. 7 illustrates an example call flow in accordance with techniques of the present disclosure. In this example, the serving base station can share its cell ID and/or UE ID of the terminal (e.g. with a periodical update, with an update prompted by a change or updated activation in the network, upon receipt of a wake-up signal configuration request from the terminal, etc.) and/or wake-up signal configuration.

The terminal sends a wake-up uplink which is received by the candidate base station, such as a UAV or other type of base station. If identifiers and/or configuration have been previously received from the base station, these may be used to enable a successful receipt of the wake-up signal by the candidate base station.

Upon receipt of the wake-up signal (and if appropriate, after a candidate base station selection or decision procedure), the candidate base station can activate and provide an air interface to the terminal, thereby transitioning out of a dormant state where it was reducing power consumption by only monitoring wake-up signals on the receiver and/or by deactivating its transmitter.

Once the candidate base station is active, the terminal can start using the base station. As illustrated in FIG. 7, in cases where handovers are network-initiated, the serving base station can send (or forward from the candidate base station) handover information for the terminal to hand off to the candidate base station. If appropriate, e.g. if the serving base station does not already have sufficient information to transmit the handover information to the terminal, the candidate base station can send handover information to the serving base station. This may be done upon receipt of the wake-up signal from the terminal and/or upon request from the serving base station and/or once a collective decision has been reached amongst candidate base stations having received the wake-up signal. For example, it may be conceivable that the candidate base station may await a selection confirmation from the serving base station or from the collective decision from candidate base stations (if either is applicable) and the handover information, if transmitted, may be sent in response to this confirmation. It should however be noted that in other cases the candidate base station may always notify the serving base station that it has received the wake-up signal (with or without sending handover information) and the candidate may assume that it has been selected if the terminal connects to it. It may otherwise assume that the terminal has either been directed to another candidate base station (or will no longer try to connect to a candidate base station) and can return to a dormant state.

As mentioned above, in cases where more than one candidate base station may have received the wake up signal, a selection procedure may be used to select a base station from these candidate base stations—for example based on which one is deemed the best or optimal candidate base station for the specific UE and/or for the area. Such a selection may be based on information such as load, capacity, location, interference level, slide information, mobility status, power level for the candidate base station, for the serving base station and/or any other candidate base station having received the wake-up signal. In cases where the techniques discussed herein are implemented in a DU-CU architecture, and if the serving base station is making the decision, it is expected that the CU of the serving base station will make this selection decision.

As the skilled person will appreciate, using the cell ID for scrambling the wake-up signal may also be beneficial as it can allow the candidate base station to identify which is the current serving base station for the terminal. In cases where more than one candidate base station detects the wake-up signal, the serving base station (e.g. CU in a CU-DU architecture) can provide a centralisation role by identifying which candidate base station(s) have received the signal and which one is selected for providing an air interface to the terminal (and/or a collective decision may be made amongst the candidate base station having received the wake-up signal). As it is unlikely that the system would be able to predict how many base stations will detect the signal, such a centralised procedure can be helpful. However, it will appreciated that in other cases, the network can be designed such that no more than one candidate base station is provided near a main base station and/or the candidate base station(s) may not rely on a centralised procedure to select the optimal one for the terminal.

FIG. 8 illustrates another simplified diagram of infrastructure equipment, such as a base station, in accordance with techniques of the present disclosure. From one perspective, the base station (or other type of infrastructure equipment can be seen as comprising, amongst other things, a power supply, a transmitter (“RF Tx”), a receiver (RF Rx”), a power amplifier and a signal processing function. It is often expected that the base station will comprise some cooling capabilities.

When the base station is in sleep or dormant state, some of the more power greedy functions of the base station, e.g. the signal processing module, RF transmitter and power amplifier could be switched off or deactivated. The base station can operate using a minimal number of functions to monitor for wake-up signals. For example, the base station may keep the receiver and wake-up signal receiver function active with a view to detecting any potential UL wake-up signal from UEs. When a wake-up signal is received, any modules which may be needed and which was deactivated can be switched on or re-activated in order to perform the relevant functions (e.g. processing, transmission, reception function).

It is also noteworthy that the receiver may operate in a reduced power mode compared to normal (active) operation of the base station. For example, it may only monitor UL transmissions in fewer time and/or frequency resources compared to the operation of the base station when it is providing the air interface to a terminal. Accordingly, even if the receiver is still in operation, it can be configured to operate at a reduced power mode when monitoring for wake-up signals. Additionally or alternatively, power savings may be made in the cooling of the equipment. As the base station will be operating fewer functions, at a reduced capability mode, the equipment is expected to generate less heat and thus to require less cooling compared to a conventional operation mode (e.g. when providing an air interface to terminals).

When the base station is activated, it is expected that conventional cell and terminal detection and access procedures can be resumed and the system is unlikely to rely on the use of wake-up signals to detect the base station. Accordingly, in some examples the wake-up signal receiver function may be deactivated when the base station is activated or is not dormant.

From one perspective, the (candidate) base station can be configured to include a wake-up signal receiver function to receive potential wake-up signal even when dormant. When dormant and before it receives any wake-up signal (e.g. from a UE or from a serving base stations), some of other modules such as signal processing, RF transmitter and/or power amplifier modules could be switched off.

In accordance to some techniques discussed herein, connected UEs that have determine that they will initiate a base station (or other infrastructure equipment) search and which will thus want the neighbouring base station(s) to receive a wake-up signal identifying them as the source, it can send UL wake-up signal request to its serving gNB. The terminal can transmit an UL wake-up signal (e.g. according to any configuration received in response to the request) or the request may prompt the serving base station to send the wake-up signal on behalf of the terminal. This UL wake-up signal can be scrambled with the identifiers for the serving cell and/or the terminal.

Once the candidate base station receives UL wake-up signal, it can transition out of the dormant state and start operate to provide an air interface to the terminal. For example, in some cases it can start transmitting reference signals for synchronization, system information, etc. In the case where synchronization is not required, the candidate base station—once it has been activated—can communicate with the terminal directly. For example, it may send a wake-up acknowledgement signal to UE and the can start using the air interface.

In some cases, the use of the wake-up signal may be employed to assist the system in tracking or following the terminal, for example with a view to providing better QoS for the UE.

For example, the UE may be configured to send a wake-up signal when one or more conditions are met, for example:
1. When UE changes its moving status and/or trajectory.
2. When UE detects an increase in the number retransmissions (e.g. as measured on a rolling period).

As before, in some cases the UE can send a UL wake-up signal using configuration received from its serving cell. In response to the wake-up signal, rather than searching for another base station, the serving gNB may adjust communication parameters such as resource allocation, transmission angle, etc. In cases where the terminal may be able to communicate with two or more base stations (e.g. a terminal having a first serving base station and a second serving base station at the same time), the two or more base stations may coordinate their respective transmission configurations (e.g. transmission power, directional configuration, resource allocation etc.) in order to reduce the likelihood of noise or interferences between transmissions to and/or from the two or more base stations.

It should be noted that in this case or in other cases, the transmission of the wake-up signal may be based on the transmission of a signal or on the transmission of a repeated signal. For example, the signal may be transmitted periodically within a time period (which may for example be measured using a timer). For example, the terminal may be configured to send the wake-up signal every second (where 1 s is the period or duration) during 10 seconds (where 10 s is the time period or repetition period) after the first signal transmission or after the determination that the terminal will search for a base station by sending a signal.

Additionally, while handover to the candidate base station has been discussed, the terminal may but does not have to terminate its connection to the serving base station when using the air interface provided by the candidate base station. For example, the terminal may operate in a mode where it maintains a connection with the (original) serving base station and also uses the air interface provided by the candidate base station (e.g. it may set up an additional connection with the candidate base station when this is part of using the air interface to communicate with the candidate base station). This can be for example for the candidate base station to provide an additional service while the terminal is still able to use one or more services provided by the serving base station.

### Non-Connected Mode

In other cases, the terminal may not be in connected mode when sending a wake-up signal. For example, using the terminology of some legacy systems, the terminal may be in idle or inactive (e.g. RRC_IDLE or RRC_INACTIVE mode).

In such cases, the wake-up signal may be useful to assist UE in selecting, re-selecting and/or camping on a suitable base station and to identify a base station deemed or considered the optimal one amongst (dormant or active) base stations in the area.

The terminal may trigger a base station search based on any combination of the following criteria:
1. The UE is about to transition to a connected mode (e.g. RRC_CONNECTED mode)—the terminal may then increase the likelihood of finding the best base station it can communicate with, including dormant ones that the terminal would otherwise not be able to detect.
2. The UE changes its moving status and/or trajectory—the terminal can again detect base station which it may otherwise not be aware of, which can be helpful if the terminal is geographically mobile.
3. The UE is about to perform a cell re-selection procedure—again, this may help the terminal detect suitable neighbouring base station, including dormant ones that it would otherwise not consider in the cell re-selection procedure.

It should also be noted that while the terminal can send a wake-up signal on an on-demand basis when it determines that it should start a base station search, a periodicity criterion may also be combined with the on-demand transmission of the signal. For example, the terminal may transmit the signal on-demand and, if a period has expired since the signal was last sent, the terminal may send another signal. This combination may enable the terminal to increase this maximum time between two wake-up signal transmissions relative to a purely periodical arrangement. This is because the periodical transmission may be performed as an additional and/or precautionary mechanism and because most useful signal transmissions are expected to be captured by the on-demand mechanisms. Accordingly, this time period can be lengthened with a view to reducing power consumption of the overall system, even if there is a periodical configuration aspect to the transmissions of the signal.

In cases where the UE needs additional configuration for sending the wake-up signal, the UE can sometimes obtain wake-up signal configuration information from signalling broadcasted by a base station. For example, the UE may receive system information such as System Information Block “SIB” which may include wake-up signal configuration for at least one neighbouring possibly dormant base station. As discussed above in respect of connected UEs, not all configurations may be obtained from a nearby base station. For example, one or more wake-up signal configurations may be pre-configured in advance in the terminal and candidate base station. This can be beneficial for case where the UE moves out of coverage of al neighbouring base stations. It is also conceivable that the two or more configurations can be used in parallel. For example, candidate base stations may monitor for wake-up signals based on a configuration shared with neighbouring base station (which might have been shared with terminals in the area) and may also monitor for wake-up signals based on a pre-configured configuration which can be used by terminals, for example by terminals unable to (or not configured to) obtain other configuration information from the network.

As above, if two or more base stations detect the wake-up signal, there may be in some case be a co-ordination procedure in place in order to decide which of the candidate base station might be the most desirable base station to allow the terminal to camp on or to use. In such cases, the selected base station may be configured to then transmit downlink reference signals which will increase the likelihood of the selected base station to be identified by the terminal as the best candidate base station. For example, it may increase the power of the reference signals and/or point the signals or beams for transmitting the signal towards the UE (for example by pointing them in the direction of where the wake-up signal where received by the base station). Accordingly, the UE is likely to identify the base station as a strong or as the strongest candidate for camping on its cell or connecting. It should also be noted that such techniques and teachings may also be used for terminals in connected mode.

Accordingly, non-connected UEs such as idle or inactive UEs can receive corresponding configuration from a serving cell (if camping) or a neighbouring cell through broadcasted signalling and/or use pre-configured configurations (e.g. for when it moves out of coverage). In cases where the terminal is expected to select a base station based on reference signals received from base stations, a candidate base station (such as a preferred candidate base station after a coordination procedure is performed to identify an optimal candidate base station among candidate base stations) may send reference signals pointing to the UE and/or at an increased power. For example, the base station may increase the power of the reference signal for a time period following the receipt of the wake-up signal

Conventionally, the candidate base station (once activated) would be expected to return to a sleep or dormant mode if it hasn't had any activity (e.g. traffic and/or user in connected mode) for a certain time period and may thus implement an inactive timer. Additionally or alternatively, the UE explicitly may also send an indication to base station to inform the base station that it can go to sleep and the base station can decide whether to transition to a dormant state using this indication. However, there may be cases where the base station is going to a dormant state while one or more UEs are expecting the base station to remain active, even if the terminal does not transmit to the base station. For example, an idle UE in the coverage of the activated base station may have found the base station and may expect to remain within the coverage for a specific service (e.g. MBS) which is provided by the base station, even if it does not presently send traffic and does not do so for a time period which is possibly longer than an inactivity timer of the base station.

According to some implementation, when base station (or relay, infrastructure equipment, etc.) is about to go to sleep, it may check whether one or more terminals (e.g. idle terminals) within coverage plan to use the base station. The base station can send a notification that the base station intends to transition to a dormant or sleeping state, for example by paging or using system information. Idle UEs receiving the notification may in return send a “keep awake” signal in order to stop the base station from transitioning to a sleep mode, for example to request the base station to extend the operation in case the UE plans to use the service(s) it provides.

Accordingly, if a non-connected terminal determines that the base station is likely to transition to a dormant state, the terminal may send a keep awake signal to base station, with a view to preventing the base station to going back to sleep. Such keep awake signal transmissions can in some cases be triggered by a “going to sleep” signal received by the terminal from base station or may be transmitted periodically.

As previously mentioned, where a reference is made to a base station which is serving the terminal or which is a candidate for serving the terminal, the same teachings apply equally to a relay node, an IAB node or any other type of infrastructure equipment. For example a wake-up or keep awake signal as discussed herein can also be used for activating a relay node. Such a signal (or signals) may be configured separately (in addition to) a conventional discovery signal and may re-use some of a relay discovery signal. It should also be noted that a relay scenario could for example be a vehicle relay, a UE-to-UE relay, a UE-to-Network relay (PC5 based), UE relay (Uu based), drone/satellite relay (NTN interface based), etc.

Turning to the configurations of wake up signals (e.g. frequency, bandwidth, time and/or periodicity), such configuration may in case differ depending on the targeted use case and/or on the desired services. Such different configurations may be provided by the corresponding serving and/or candidate base stations who can support the wake-up signal and related services. This can enable receivers of the wake-up signal to determine their own suitability to serve the terminal.

If using different wake-up signals configured with different services or use cases, connected UEs can in some examples identify the desired services or use case in a wake-up signal request to the serving base station. Also for idle/inactive UEs, supported wake-up signals may be included in system information.

For example, the system may be configured with:
1. Different services (e.g. (e)MBB, URLLC, mIOT, etc.) having different wake-up signal configurations.
2. Different types of base stations or infrastructure equipment (e.g. drone, IOT relays, rural areas nomadic base stations, etc,) having different wake-up signal configurations.
3. Special services (emergency, contingency) having their own unique configurations which may not be allocated to any other service (e.g. even in a different location).

It is also noteworthy that the wake-up signal may be configured outside of a frequency band allocated to a mobile network (e.g. 5G and/or 6G bands) but instead in a pre-defined frequency band with a pre-defined pattern. One limitation with having a wake-up signal in 5G/6G spectrum is that it can make the spectrum allocation complex and it is difficult to know how many frequency bands are available for use or which frequency is used by these base stations as many different combinations may be used. Accordingly, the complexity associated with the configuration and support of such frequency bands on the same base station in order to support wake-up signal may increase. By using a predefined frequency band outside the allocated 5G or 6G bands, this complexity may be reduced. While the complexity is a factor, there are also benefits in transmitting the wake-up signal within an allocated frequency band (e.g. for 5G/6G band) as the terminal may not have to have to support an additional frequency band. Also, if the wake-up signal is used by the candidate base station to determine whether it would be appropriate to activate or by the serving base station or another node to determine which candidate base station might be best, a wake-up signal in a frequency band corresponding to the technology used after the transition to an active mode is expected to give a better reflection of the link between the terminal and candidates.

Additionally, the method steps discussed herein may be carried out in any suitable order. For example, steps may be carried out in an order which differs from an order used in the examples discussed above or from an indicative order used anywhere else for listing steps (e.g. in the claims), whenever possible or appropriate. Thus, in some cases, some steps may be carried out in a different order, or simultaneously or in the same order. So long as an order for carrying any of the steps of any method discussed herein is technically feasible, it is explicitly encompassed within the present disclosure.

As used herein, transmitting information or a message to an element may involve sending one or more messages to the element and may involve sending part of the information separately from the rest of the information. The number of “messages” involved may also vary depending on the layer or granularity considered. For example, transmitting a message may involve using several resource elements in an LTE or NR environment such that several signals at a lower layer correspond to a single message at a higher layer. Also, transmissions from one node to another may relate to the transmission of any one or more of user data, system information, control signalling and any other type of information to be transmitted. It will also be appreciated that some information may be notified or indicated implicitly rather than through the use of an explicit indicator.

Also, whenever an aspect is disclosed in respect of an apparatus or system, the teachings are also disclosed for the corresponding method and for the corresponding computer program. Likewise, whenever an aspect is disclosed in respect of a method, the teachings are also disclosed for any suitable corresponding apparatus or system as well as for the corresponding computer program. Additionally, it is also hereby explicitly disclosed that for any teachings relating to a method or a system where it has not been clearly specified which element or elements are configured to carry out a function or a step, any suitable element or elements that can carry out the function can be configured to carry out this function or step. For example, any one or more of a mobile node or network node may be configured accordingly if appropriate, so long as it is technically feasible and not explicitly excluded.

Whenever the expressions “greater than” or “smaller than” or equivalent are used herein, it is intended that they disclose both alternatives “and equal to” and “and not equal to” unless one alternative is expressly excluded.

It will be appreciated that while the present disclosure has in some respects focused on some example implementations which are expected to provide the primary use cases at present, the same teachings and principles can also be applied to other wireless telecommunications systems and in particular to other generations of wireless telecommunications systems such as LTE, 4G, 5G, NR, 6G, etc. and to any arrangement possibly compliant with any future version of telecom standards—defined by the 3GPP standardisation groups or by other groups. Accordingly, the teaching provided herein using for example 3GPP terminology can be equally applied to other systems with reference to the corresponding functions.

It will be appreciated that the principles described herein are applicable not only to certain types of communications device, but can be applied more generally in respect of any types of communications device. For example, while the techniques are expected to be particularly useful for NTN systems, the skilled person will appreciate that they can also be applied to other systems which for example face similar challenges and which are expected to benefit in a similar manner.

It is noteworthy that where a “predetermined” element is mentioned, it will be appreciated that this can include for example a configurable element, wherein the configuration can be done by any combination of a manual configuration by a user or administrator or a transmitted communication, for example from the network or from a service provider (e.g. a device manufacturer, an OS provider, etc.).

Techniques discussed herein can be implemented using a computer program product, comprising for example computer-readable instructions stored on a computer readable medium which can be executed by a computer, for carrying out a method according to the present disclosure. Such a computer readable medium may be a non-transitory computer-readable storage medium with an executable program stored thereon, wherein the program instructs a microprocessor to perform said method. Additionally, or alternatively, the techniques discussed herein may be realised at least in part by a computer readable communication medium that carries or communicates code in the form of instructions or data structures and that can be accessed, read, and/or executed by a computer.

In other words, any suitable computer readable medium may be used, which comprises instructions and which can for example be a transitory medium, such as a communication medium, or a non-transitory medium, such as a storage medium. Accordingly, a computer program product may be a non-transitory computer program product.

Further particular and preferred aspects of the present invention are set out in the accompanying independent and dependent claims. It will be appreciated that features of the dependent claims may be combined with features of the independent claims in combinations other than those explicitly set out in the claims.

Thus, the foregoing discussion discloses and describes merely examples of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, define, in part, the scope of the foregoing claim terminology such that no inventive subject matter is dedicated to the public.

Further examples of the present disclosure are set out in the following numbered clauses:

Clause 1. A mobile telecommunications system comprising first infrastructure equipment and a terminal wherein the terminal is configured to communicate with the first infrastructure equipment via an air interface provided by the first infrastructure equipment,

wherein the terminal is configured to:
determine that the terminal can trigger an infrastructure equipment search; transmit, based on determining that the terminal can trigger an infrastructure equipment search, a wake-up signal;

wherein the first infrastructure equipment is configured to:
based on the wake-up signal from the terminal, transition to an active state where the first infrastructure equipment provides the air interface for the terminal to communicate with the first infrastructure equipment.
   Clause 2. The system of Clause 1 wherein the first infrastructure equipment is configured to transition to the active state from a dormant state, the dormant state being state in which the first infrastructure equipment does not provide the air interface and in which the first infrastructure equipment monitors uplink signals for wake-up signals.
   Clause 3. The system of Clause 1 or 2 wherein the first infrastructure equipment is configured to transition to the active state from a dormant state, the dormant state being state in which the transmitter of the first infrastructure equipment is inactive.
   Clause 4. The system of any one of Clauses 1 to 3 wherein, the terminal is configured to determine that the terminal can trigger an infrastructure equipment search while the terminal is connected to a second infrastructure equipment.
   Clause 5. The system of Clause 4 wherein the terminal is configured to determine that the terminal can trigger an infrastructure equipment search based on one or more of:
the terminal determining that the second infrastructure equipment does not provide a service that the terminal is configured to use;
the terminal determining that its coverage level is degrading;
the terminal determining that its coverage level is degrading and that the terminal cannot identify a currently active infrastructure equipment with a suitable coverage level;
the terminal determining that its coverage level is dropping under a predetermined threshold;
the terminal determining that its coverage level is dropping under a predetermined threshold and that
the terminal cannot identify a currently active infrastructure equipment with a suitable coverage level;
the terminal determining that a moving status or trajectory for the terminal has changed;
the terminal determining that a number of retransmissions is increasing;
the terminal determining that a congestion level is above an acceptable congestion level; and
the terminal determining that an interference level is above a suitable interference level.
   Clause 6. The system of Clause 4 or 5, wherein the second infrastructure equipment is configured to notify the terminal of one or more resources for the terminal to transmit a wake-up signal.
   Clause 7. The system of Clause 6, wherein the first infrastructure equipment is configured to notify the second infrastructure equipment terminal of the one or more resources for the terminal to transmit a wake-up signal prior to the notification to the terminal of the one or more resources for the terminal to transmit a wake-up signal.
   Clause 8. The system of Clause 6 or 7, wherein
the terminal is configured to transmit a wake-up signal configuration request; and
the second infrastructure equipment is configured to notify the terminal of one or more resources for the terminal to transmit a wake-up signal in response to the wake-up signal configuration request.
   Clause 9. The system of Clause 8 wherein the second infrastructure equipment is configured to, after receiving the wake-up signal configuration request from the terminal, communicate to the first infrastructure equipment one of or both of a cell identifier for a cell provided by the second infrastructure equipment and a terminal identifier for the terminal.
   Clause 10. The system of any one of Clauses 4 to 9, wherein the terminal is configured to transmit a scrambled signal as the wake-up signal, the scrambled signal being scrambled with one of or both of a cell identifier for a cell provided by the second infrastructure equipment and a terminal identifier for the terminal.
   Clause 11. The system of Clause 10 wherein the first infrastructure equipment is configured to recognise one of or both of the cell identifier and the terminal identifier, respectively, from the scrambled signal.
   Clause 12. The system of Clause 10 or 11 wherein the second infrastructure equipment is configured to transmit one or both of the cell identifier and the terminal identifier to the first infrastructure equipment.
   Clause 13. The system of any one of Clauses 4 to 12, wherein the second infrastructure equipment is configured to, upon receipt of the wake-up signal by the second infrastructure equipment, to transmit a further wake-up signal, the further wake-up signal being associated with an identifier for the terminal.
   Clause 14. The system of any one of Clauses 4 to 13,
wherein the second infrastructure equipment is configured to transmit wake-up signal configuration information to the terminal, the wake-up signal configuration information identifying one or more time and/or frequency resources for transmitting the wake-up signal;
wherein the terminal is configured to transmit the wake-up signal based on the received wake-up signal configuration information; and
wherein the first infrastructure equipment is configured to detect the wake-up signal from the terminal based on the wake-up signal configuration information.
   Clause 15. The system of any one of Clauses 4 to 14, wherein the terminal is configured to, upon determining that the terminal can trigger an infrastructure equipment search, transmit a configuration information request to the second infrastructure equipment and to, upon receipt of a configuration request response, transmit the wake-up signal based on the configuration request response.
   Clause 16. The system of any one of Clauses 4 to 15, wherein the second infrastructure equipment is configured to select the first infrastructure equipment from a plurality of infrastructure equipment having detected the wake-up signal, for transitioning the first infrastructure equipment to the active state.
   Clause 17. The system of Clause any one of Clauses 4 to 15,
wherein the first infrastructure equipment is configured to communicate with one or more further infrastructure equipment, based on the one or more further infrastructure equipment receiving the wake-up signal from the terminal, to elect one of the first infrastructure equipment and the one or more further infrastructure equipment for transitioning to the active state;
wherein the first infrastructure equipment is configured to transition to the active state when the elected infrastructure equipment is the first infrastructure equipment.
   Clause 18. The system of Clause any one of Clauses 4 to 15, wherein upon receipt of the wake-up signal from the terminal, the first infrastructure equipment is configured to transition to a broadcasting state wherein, in the broadcasting state, the first infrastructure equipment is configured to transmit a reference signal.
   Clause 19. The system of Clause 18 wherein the first infrastructure equipment is configured to determine that the first infrastructure equipment has been in the broadcasting state for at least a predetermined amount of time and that the terminal has not contacted the first infrastructure equipment; and wherein the first infrastructure equipment is configured to transition, based on the determination, from the broadcasting state to a dormant state, the dormant state being state in which the first infrastructure equipment does not provide the air interface and in which the first infrastructure equipment monitors uplink signals for wake-up signals.
   Clause 20. The system of Clause any one of Clauses 4 to 19 wherein the second infrastructure equipment is configured to transmit to the terminal handover or connection information for the first infrastructure equipment.
   Clause 21. The system of any preceding Clause, wherein the terminal is configured to transmit the wake-up signal and wherein receipt by the first infrastructure equipment of the wake-up signal from the terminal comprises the first infrastructure equipment detecting the wake-up signal.
   Clause 22. The system of any preceding Clause wherein when the terminal is in a non-connected state, the terminal is configured to determine that the terminal can trigger an infrastructure equipment search based on one or more of:
the terminal determining that it will transition to a connected state;
the terminal determining that it will perform a cell selection or re-selection procedure; and
the terminal determining that a moving status or trajectory for the terminal has changed;
   Clause 23. The system of any preceding Clause wherein the first infrastructure equipment is configured to transmit, once transitioned to the active state, one or more of: a reference signal, system information and synchronisation information.
   Clause 24. The system of Clause 23, wherein the first infrastructure equipment is configured to transmit the reference signal at a higher power during in a time period following the detection of the wake-up signal and/or by directing its transmitter in a detected direction of the terminal based on the detection of the wake-up signal.
   Clause 25. The system of any preceding Clause wherein the first infrastructure equipment is configured to
Clause determine, while in the active state, if it has received a keep-awake message;
if a keep-awake message is received, remain in the active state; and
if a keep-awake message is not received, transition to a dormant state.
   Clause 26. The system of Clause 25 wherein the first infrastructure equipment is configured to transmit, while in the active state, a notification indicating that the first infrastructure equipment intends to go to sleep, wherein the keep-awake message is in response to the notification.
   Clause 27. The system of any preceding Clause, wherein
the terminal is configured to transmit the wake-up signal based on a first transmission configuration when the determination that the terminal can trigger an infrastructure equipment search is based on a first criterion and wherein the terminal is configured to transmit the wake-up signal based on a second transmission configuration when the determination that the terminal can trigger an infrastructure equipment search is based on a second criterion; and
the first infrastructure equipment is configured to transition to the active state based on whether the transmission configuration used for transmitting the wake-up signal is associated with a criterion matching the first infrastructure equipment.
   Clause 28. Infrastructure equipment for use in a mobile telecommunications system comprising a terminal wherein the infrastructure equipment is configured to provide an air interface for the terminal and wherein the terminal is configured to communicate with the infrastructure equipment via the air interface, wherein the infrastructure equipment is configured to:
based on detecting that the terminal has transmitted a wake-up signal, transition to an active state where the infrastructure equipment provides the air interface for the terminal to communicate with the infrastructure equipment, wherein the transmission by the terminal of the wake-up signal is based on determining that the terminal can trigger an infrastructure equipment search.
   Clause 29. The infrastructure equipment of Clause 28 wherein the infrastructure equipment is configured to transition to the active state from a dormant state, the dormant state being state in which the infrastructure equipment does not provide the air interface and in which the infrastructure equipment monitors uplink signals for wake-up signals.
   Clause 30. The infrastructure equipment of Clause 28 or 29 wherein the infrastructure equipment is configured to transition to the active state from a dormant state, the dormant state being state in which the transmitter of the infrastructure equipment is inactive.
   Clause 31. The infrastructure equipment of any one of Clauses 28 to 30 wherein, the wake-up signal was transmitted while the terminal is connected to a second infrastructure equipment.
   Clause 32. The infrastructure equipment of Clause 31, wherein the infrastructure equipment is configured to notify the second infrastructure equipment terminal of one or more resources for the terminal to transmit a wake-up signal prior to the notification to the terminal of the one or more resources for the terminal to transmit a wake-up signal.
   Clause 33. The infrastructure equipment of Clause 31 or 32 wherein the infrastructure equipment is configured to receive, from the second infrastructure equipment, one of or both of a cell identifier for a cell provided by the second infrastructure equipment and a terminal identifier for the terminal.
   Clause 34. The infrastructure equipment of Clause 33 wherein the infrastructure equipment is configured to recognise one of or both of the cell identifier and the terminal identifier, respectively, by descrambling the wake up signal from the terminal.
   Clause 35. The infrastructure equipment of any one of Clauses 31 to 34, further configured to communicate with one or more further infrastructure equipment, based on the one or more further infrastructure equipment receiving the wake-up signal from the terminal, to elect one of the infrastructure equipment and the one or more further infrastructure equipment for transitioning to the active state; and
transition to the active state when the elected infrastructure equipment is the infrastructure equipment.
   Clause 36. The infrastructure equipment of any one of Clauses 31 to 35, further configured to transition, upon receipt of the wake-up signal from the terminal, to a broadcasting state wherein, in the broadcasting state, the infrastructure equipment is configured to transmit a reference signal.
   Clause 37. The infrastructure equipment of Clause 36 further configured to
determine that the infrastructure equipment has been in the broadcasting state for at least a predetermined amount of time and that the terminal has not contacted the infrastructure equipment in the predetermined amount of time;
transition, based on the determination, from the broadcasting state to a dormant state, the dormant state being state in which the infrastructure equipment does not provide the air interface and in which the infrastructure equipment monitors uplink signals for wake-up signals.
   Clause 38. The infrastructure equipment of any one of Clauses 31 to 37, configured to receive the wake-up signal from the second infrastructure equipment.
   Clause 39. The infrastructure equipment of any one of Clauses 28 to 38, configured to receive the wake-up signal from the terminal.
   Clause 40. The infrastructure equipment of any one of Clauses 28 to 39 further configured to transmit, once transitioned to the active state, one or more of: a reference signal, system information and synchronisation information.
   Clause 41. The infrastructure equipment of Clause 40, further configured to transmit the reference signal at a higher power during in a time period following the detection of the wake-up signal and/or to transmit the reference signal by directing its transmitter in a detected direction of the terminal based on the detection of the wake-up signal.
   Clause 42. The infrastructure equipment of any one of Clauses 28 to 41 wherein the infrastructure equipment is configured to
determine, while in the active state, if it has received a keep-awake message;
if a keep-awake message is received, remain in the active state; and
if a keep-awake message is not received, transition to a dormant state.
   Clause 43. The infrastructure equipment of Clause 42 wherein the infrastructure equipment is configured to transmit, while in the active state, a notification indicating that the infrastructure equipment intends to go to sleep, wherein the keep-awake message is in response to the notification.
   Clause 44. The infrastructure equipment of any one of Clauses 28 to 43, wherein when the determination that the terminal can trigger an infrastructure equipment search is based on a first criterion, the transmission of the wake-up signal is based on a first transmission configuration and when the determination that the terminal can trigger an infrastructure equipment search is based on a second criterion, the transmission of the wake-up signal is based on a second transmission configuration; and
the infrastructure equipment is configured to transition to the active state based on whether the transmission configuration used for transmitting the wake-up signal is associated with a criterion matching the infrastructure equipment.
   Clause 45. A terminal for use in a mobile telecommunications system comprising first infrastructure equipment and the terminal, wherein the terminal is configured to communicate with the first infrastructure equipment via an air interface provided by the first infrastructure equipment, wherein the terminal is configured to:
determine that the terminal can trigger an infrastructure equipment search; and transmit, based on determining that the terminal can trigger an infrastructure equipment search, a wake-up signal.
   Clause 46. The terminal of Clause 45 further configured to communicating with the first infrastructure equipment, once the first infrastructure equipment has transitioned to an active state where the first infrastructure equipment provides the air interface for the terminal to communicate with the first infrastructure equipment.
   Clause 47. The terminal of Clause 45 or 46 wherein, the terminal is configured to determine that the terminal can trigger an infrastructure equipment search while the terminal is connected to a second infrastructure equipment.
   Clause 48. The terminal of Clause 47 wherein the terminal is configured to determine that the terminal can trigger an infrastructure equipment search based on one or more of:
the terminal determining that the second infrastructure equipment does not provide a service that the terminal is configured to use;
the terminal determining that its coverage level is degrading;
the terminal determining that its coverage level is degrading and that the terminal cannot identify a currently active infrastructure equipment with a suitable coverage level;
the terminal determining that its coverage level is dropping under a predetermined threshold;
the terminal determining that its coverage level is dropping under a predetermined threshold and that the terminal cannot identify a currently active infrastructure equipment with a suitable coverage level;
the terminal determining that a moving status or trajectory for the terminal has changed;
the terminal determining that a number of retransmissions is increasing;
the terminal determining that a congestion level is above an acceptable congestion level; and
the terminal determining that an interference level is above a suitable interference level.
   Clause 49. The terminal of Clause 47 or 48, further configured to receive, from the second infrastructure equipment, a notification of one or more resources for the terminal to transmit a wake-up signal.
   Clause 50. The terminal of Clause 49, further configured to transmit a wake-up signal configuration request; and
receive, signal in response to the wake-up signal configuration request and from the second infrastructure equipment, a notification of one or more resources for the terminal to transmit a wake-up.
   Clause 51. The terminal of any one of Clauses 47 to 50, wherein the terminal is configured to transmit a scrambled signal as the wake-up signal, the scrambled signal being scrambled with one of or both of a cell identifier for a cell provided by the second infrastructure equipment and a terminal identifier for the terminal.
   Clause 52. The terminal of any one of Clauses 47 to 51, further configured to
receive, from the second infrastructure equipment, wake-up signal configuration information, the wake-up signal configuration information identifying one or more time and/or frequency resources for transmitting the wake-up signal;
transmit the wake-up signal based on the received wake-up signal configuration information.
   Clause 53. The terminal of any one of Clauses 47 to 52, further configured to, upon determining that the terminal can trigger an infrastructure equipment search, transmit a configuration information request to the second infrastructure equipment and to, upon receipt of a configuration request response, transmit the wake-up signal based on the configuration request response.
   Clause 54. The terminal of any one of Clauses 47 to 53, further configured to detect, after transmission of the wake-up signal, a reference signal transmitted by the first infrastructure equipment and to use the air interface provided by the first infrastructure equipment based on the received reference signal.
   Clause 55. The terminal of any one of Clauses 45 to 54, wherein when the terminal is in a non-connected state, the terminal is configured to determine that the terminal can trigger an infrastructure equipment search based on one or more of:
the terminal determining that it will transition to a connected state;
the terminal determining that it will perform a cell selection or re-selection procedure; and
the terminal determining that a moving status or trajectory for the terminal has changed;
   Clause 56. The terminal of any one of Clauses 45 to 55 further configured
upon receipt from the first infrastructure equipment of a notification indicating that the first infrastructure equipment intends to go to sleep, to determine whether the terminal intends to maintain the first infrastructure equipment in an active state; and
upon determination that the terminal intends to maintain the first infrastructure equipment in an active state, transmit a keep-awake message to the first infrastructure equipment.
   Clause 57. The terminal of any one of Clauses 45 to 56 further configured to connect to the first infrastructure equipment based on handover or connection information for the first infrastructure equipment received from the second infrastructure equipment.
   Clause 58. Infrastructure equipment for assisting an on-demand wake-up procedure for first infrastructure equipment and for use in a mobile telecommunications system comprising the first infrastructure equipment, the infrastructure equipment and a terminal wherein the terminal is configured to communicate with the first infrastructure equipment via a first air interface provided by the first infrastructure equipment and is configured to communicate with the infrastructure equipment via a second air interface provided by the infrastructure equipment,
wherein the terminal is configured to transmit, while connected to the infrastructure equipment, a wake-up signal and wherein the first infrastructure equipment is configured to transition, based on the wake-up signal from the terminal, to an active state where the first infrastructure equipment provides the air interface for the terminal to communicate with the first infrastructure equipment,
wherein the infrastructure equipment is configured to notify the terminal of one or more resources for the terminal to transmit the wake-up signal.
   Clause 59. The infrastructure equipment of Clause 58, wherein the infrastructure equipment is configured to receive a notification from the first infrastructure equipment terminal of the one or more resources for the terminal to transmit a wake-up signal prior to the notification to the terminal of the one or more resources for the terminal to transmit the wake-up signal.
   Clause 60. The infrastructure equipment of Clause 59, further configured to:
receive from the terminal a wake-up signal configuration request; and notify the terminal of one or more resources for the terminal to transmit a wake-up signal in response to the wake-up signal configuration request.
   Clause 61. The infrastructure equipment of Clause 60 further configured to, after receiving the wake-up signal configuration request from the terminal, communicate to the first infrastructure equipment one of or both of a cell identifier for a cell provided by the infrastructure equipment and a terminal identifier for the terminal.
   Clause 62. The infrastructure equipment of any one of Clauses 58 to 61 wherein the infrastructure equipment is configured to transmit one or both of a cell identifier and a terminal identifier to the first infrastructure equipment.
   Clause 63. The infrastructure equipment of any one of Clauses 58 to 62, further configured to, upon receipt of the wake-up signal, transmit a further wake-up signal, the further wake-up signal being associated with an identifier for the terminal.
   Clause 64. The infrastructure equipment of any one of Clauses 58 to 63, further configured to: to transmit wake-up signal configuration information to the terminal, the wake-up signal configuration information identifying one or more time and/or frequency resources for transmitting the wake-up signal.
   Clause 65. The infrastructure equipment of any one of Clauses 58 to 64, further configured to transmit, in response to a configuration information request from the terminal, a configuration request response.
   Clause 66. The infrastructure equipment of any one of Clauses 58 to 65, further configured to select the first infrastructure equipment from a plurality of infrastructure equipment having detected the wake-up signal, for transitioning the first infrastructure equipment to the active state.
   Clause 67. The infrastructure equipment of any one of Clauses 58 to 66 further configured to transmit to the terminal handover or connection information for the first infrastructure equipment.
   Clause 68. A method of operation a terminal for use in a mobile telecommunications system comprising first infrastructure equipment and the terminal, wherein the terminal is configured to communicate with the first infrastructure equipment via an air interface provided by the first infrastructure equipment, the method comprising the terminal:
determining that the terminal can trigger an infrastructure equipment search; and
transmitting, based on determining that the terminal can trigger an infrastructure equipment search, a wake-up signal.
   Clause 69. Circuitry for a terminal for use in a mobile telecommunications system comprising first infrastructure equipment and the terminal, wherein the circuitry comprises a controller element and a transceiver element configured to operate together to communicate with the first infrastructure equipment via an air interface provided by the first infrastructure equipment, wherein the controller element and the transceiver element are further configured to operate together to:
determine that the terminal can trigger an infrastructure equipment search; and
transmit, based on determining that the terminal can trigger an infrastructure equipment search, a wake-up signal.
   Clause 70. A method of operating infrastructure equipment for use in a mobile telecommunications system comprising a terminal wherein the infrastructure equipment is configured to provide an air interface for the terminal and wherein the terminal is configured to communicate with the infrastructure equipment via the air interface, the method comprising the infrastructure equipment:
transitioning, based on detecting that the terminal has transmitted a wake-up signal, to an active state where the first infrastructure equipment provides the air interface for the terminal to communicate with the infrastructure equipment, wherein the transmission by the terminal of the wake-up signal is based on determining that the terminal can trigger an infrastructure equipment search.
   Clause 71. Circuitry for a infrastructure equipment for use in a mobile telecommunications system comprising a terminal, wherein the circuitry comprises a controller element and a transceiver element configured to operate together to provide an air interface for the terminal and wherein the terminal is configured to communicate with the infrastructure equipment via the air interface, wherein the controller element and the transceiver element are further configured to operate together to:
transition, based on detecting that the terminal has transmitted a wake-up signal, to an active state where the first infrastructure equipment provides the air interface for the terminal to communicate with the infrastructure equipment, wherein the transmission by the terminal of the wake-up signal is based on determining that the terminal can trigger an infrastructure equipment search.
   Clause 72. A method of operating infrastructure equipment for assisting an on-demand wake-up procedure for first infrastructure equipment and for use in a mobile telecommunications system comprising the first infrastructure equipment, the infrastructure equipment and a terminal wherein the terminal is configured to communicate with the first infrastructure equipment via a first air interface provided by the first infrastructure equipment and is configured to communicate with the infrastructure equipment via a second air interface provided by the infrastructure equipment and wherein the terminal is configured to transmit, while connected to the infrastructure equipment, a wake-up signal and wherein the first infrastructure equipment is configured to transition, based on the wake-up signal from the terminal, to an active state where the first infrastructure equipment provides the air interface for the terminal to communicate with the first infrastructure equipment, the method comprising the infrastructure equipment:
notifying the terminal of one or more resources for the terminal to transmit the wake-up signal.
   Clause 73. Circuitry for a infrastructure equipment for assisting an on-demand wake-up procedure for first infrastructure equipment and for use in a mobile telecommunications system comprising the first infrastructure equipment, the infrastructure equipment, wherein the terminal is configured to communicate with the first infrastructure equipment via a first air interface provided by the first infrastructure equipment; wherein the circuitry comprises a controller element and a transceiver element configured to operate together to provide a second air interface for the terminal and wherein the terminal is configured to communicate with the infrastructure equipment via the second air interface; wherein the terminal is configured to transmit, while connected to the infrastructure equipment, a wake-up signal and wherein the first infrastructure equipment is configured to transition, based on the wake-up signal from the terminal, to an active state where the first infrastructure equipment provides the air interface for the terminal to communicate with the first infrastructure equipment; and wherein the controller element and the transceiver element are further configured to operate together to:
notify the terminal of one or more resources for the terminal to transmit the wake-up signal.

### REFERENCES

[1] TR 38.811, “Study on New Radio (NR) to support non terrestrial networks (Release 15)”, 3rd Generation Partnership Project, September 2020.
[2] ITU-T Technical Specification FG-NET2030 “Network 2030 Architecture Framework” (June 2020)
[3] TR 38.821, “Solutions for NR to support Non-Terrestrial Networks (NTN) (Release 16)”, 3rd Generation Partnership Project, December 2019.
[4] R3-185310 “NTN RAN architecture” (August 2018) related to Study Item “FS_NR_NTN_solutions: Study on solutions for NR to support non-terrestrial networks (NTN)”
[5] “SLEEP Mode Techniques for Small Cell Deployments” by Imran Ashraf, Federico Boccardi, and Lester Ho (IEEE Communications Magazine, August 2011)

1. A mobile telecommunications system comprising first infrastructure equipment and a terminal wherein the terminal is configured to communicate with the first infrastructure equipment via an air interface provided by the first infrastructure equipment,
wherein the terminal is configured to:
determine that the terminal can trigger an infrastructure equipment search;
transmit, based on determining that the terminal can trigger an infrastructure equipment search, a wake-up signal;
wherein the first infrastructure equipment is configured to:
based on the wake-up signal from the terminal, transition to an active state where the first infrastructure equipment provides the air interface for the terminal to communicate with the first infrastructure equipment.

2. The system of claim 1 wherein the first infrastructure equipment is configured to transition to the active state from a dormant state, the dormant state being state in which the first infrastructure equipment does not provide the air interface and in which the first infrastructure equipment monitors uplink signals for wake-up signals.

3. The system of claim 1, wherein the first infrastructure equipment is configured to transition to the active state from a dormant state, the dormant state being state in which the transmitter of the first infrastructure equipment is inactive.

4. The system of claim 1, wherein, the terminal is configured to determine that the terminal can trigger an infrastructure equipment search while the terminal is connected to a second infrastructure equipment.

5. The system of claim 4, wherein the terminal is configured to determine that the terminal can trigger an infrastructure equipment search based on one or more of:
the terminal determining that the second infrastructure equipment does not provide a service that the terminal is configured to use;
the terminal determining that its coverage level is degrading;
the terminal determining that its coverage level is degrading and that the terminal cannot identify a currently active infrastructure equipment with a suitable coverage level;
the terminal determining that its coverage level is dropping under a predetermined threshold;
the terminal determining that its coverage level is dropping under a predetermined threshold and that the terminal cannot identify a currently active infrastructure equipment with a suitable coverage level;
the terminal determining that a moving status or trajectory for the terminal has changed;
the terminal determining that a number of retransmissions is increasing;
the terminal determining that a congestion level is above an acceptable congestion level; and
the terminal determining that an interference level is above a suitable interference level.

6. The system of claim 4, wherein the second infrastructure equipment is configured to notify the terminal of one or more resources for the terminal to transmit a wake-up signal.

7. The system of claim 6, wherein the first infrastructure equipment is configured to notify the second infrastructure equipment terminal of the one or more resources for the terminal to transmit a wake-up signal prior to the notification to the terminal of the one or more resources for the terminal to transmit a wake-up signal.

8. The system of claim 4, wherein the second infrastructure equipment is configured to, upon receipt of the wake-up signal by the second infrastructure equipment, to transmit a further wake-up signal, the further wake-up signal being associated with an identifier for the terminal.

9. The system of claim 4,
wherein the second infrastructure equipment is configured to transmit wake-up signal configuration information to the terminal, the wake-up signal configuration information identifying one or more time and/or frequency resources for transmitting the wake-up signal;
wherein the terminal is configured to transmit the wake-up signal based on the received wake-up signal configuration information; and
wherein the first infrastructure equipment is configured to detect the wake-up signal from the terminal based on the wake-up signal configuration information.

10. The system of claim 4, wherein the terminal is configured to, upon determining that the terminal can trigger an infrastructure equipment search, transmit a configuration information request to the second infrastructure equipment and to, upon receipt of a configuration request response, transmit the wake-up signal based on the configuration request response.

11. The system of claim 4, wherein the second infrastructure equipment is configured to select the first infrastructure equipment from a plurality of infrastructure equipment having detected the wake-up signal, for transitioning the first infrastructure equipment to the active state.

12. The system of claim 4,
wherein the first infrastructure equipment is configured to communicate with one or more further infrastructure equipment, based on the one or more further infrastructure equipment receiving the wake-up signal from the terminal, to elect one of the first infrastructure equipment and the one or more further infrastructure equipment for transitioning to the active state;
wherein the first infrastructure equipment is configured to transition to the active state when the elected infrastructure equipment is the first infrastructure equipment.

13. The system of claim 4, wherein upon receipt of the wake-up signal from the terminal, the first infrastructure equipment is configured to transition to a broadcasting state wherein, in the broadcasting state, the first infrastructure equipment is configured to transmit a reference signal.

14. The system of claim 13, wherein the first infrastructure equipment is configured to determine that the first infrastructure equipment has been in the broadcasting state for at least a predetermined amount of time and that the terminal has not contacted the first infrastructure equipment; and wherein the first infrastructure equipment is configured to transition, based on the determination, from the broadcasting state to a dormant state, the dormant state being state in which the first infrastructure equipment does not provide the air interface and in which the first infrastructure equipment monitors uplink signals for wake-up signals.

15. The system of claim 1, wherein when the terminal is in a non-connected state, the terminal is configured to determine that the terminal can trigger an infrastructure equipment search based on one or more of:
the terminal determining that it will transition to a connected state;
the terminal determining that it will perform a cell selection or re-selection procedure; and
the terminal determining that a moving status or trajectory for the terminal has changed;

16. The system of claim 1, wherein the first infrastructure equipment is configured to transmit, once transitioned to the active state, one or more of: a reference signal, system information and synchronisation information.

17. The system of claim 16, wherein the first infrastructure equipment is configured to transmit the reference signal at a higher power during in a time period following the detection of the wake-up signal and/or by directing its transmitter in a detected direction of the terminal based on the detection of the wake-up signal.

18. The system of claim 1, wherein
the terminal is configured to transmit the wake-up signal based on a first transmission configuration when the determination that the terminal can trigger an infrastructure equipment search is based on a first criterion and wherein the terminal is configured to transmit the wake-up signal based on a second transmission configuration when the determination that the terminal can trigger an infrastructure equipment search is based on a second criterion; and
the first infrastructure equipment is configured to transition to the active state based on whether the transmission configuration used for transmitting the wake-up signal is associated with a criterion matching the first infrastructure equipment.

19. Infrastructure equipment for use in a mobile telecommunications system comprising a terminal wherein the infrastructure equipment is configured to provide an air interface for the terminal and wherein the terminal is configured to communicate with the infrastructure equipment via the air interface, wherein the infrastructure equipment is configured to:
based on detecting that the terminal has transmitted a wake-up signal, transition to an active state where the infrastructure equipment provides the air interface for the terminal to communicate with the infrastructure equipment, wherein the transmission by the terminal of the wake-up signal is based on determining that the terminal can trigger an infrastructure equipment search.

20. A terminal for use in a mobile telecommunications system comprising first infrastructure equipment and the terminal, wherein the terminal is configured to communicate with the first infrastructure equipment via an air interface provided by the first infrastructure equipment,
wherein the terminal is configured to:
determine that the terminal can trigger an infrastructure equipment search; and
transmit, based on determining that the terminal can trigger an infrastructure
equipment search, a wake-up signal.

21.-27. (canceled)
